(19) United States
(12) Patent Application Publication
(10) Pub. No.: US 2023/0344014 A1
(43) Pub. Date: Oct. 26, 2023

(54) METAL-FREE HIGH VOLTAGE BATTERY

(71) Applicant: URBAN ELECTRIC POWER INC., Pearl River, NY (US)

(72) Inventors: Gautam G. YADAV, Pearl River, NY (US); Meir WEINER, Pearl River, NY (US); Aditya UPRETI, Pearl River, NY (US); Jinchao HUANG, Pearl River, NY (US); Sanjoy BANERJEE, Pearl River, NY (US)

(21) Appl. No.: 17/995,976

(22) PCT Filed: Apr. 12, 2021
(86) PCT No.: PCT/US2021/026878

§ 371 Date: Oct. 11, 2022

Related U.S. Application Data
(60) Provisional application No. 63/009,278, filed on Apr. 13, 2020.

(51) Int. Cl. H01M 10/26; H01M 4/50; H01M 4/62; H01M 50/489; H01M 50/426; H01M 10/28; H01M 50/46; H01M 4/02

(52) U.S. Cl. CPC H01M 10/26; H01M 4/50; H01M 4/625; H01M 50/489; H01M 50/426; H01M 10/28; H01M 4/623; H01M 50/46; H01M 2004/027; H01M 2300/0011; H01M 2300/0014; H01M 2004/028

(57) ABSTRACT

A high voltage metal-free battery comprising a cathode comprising a cathode electroactive material, wherein the cathode electroactive material comprises at least one of an organic compound, an oxide, a hydroxide, an oxyhydroxide, a sulfide, and combinations thereof; an anode comprising an anode electroactive material, wherein the anode electroactive material comprises at least one of an organic compound, an oxide, a hydroxide, an oxyhydroxide, a sulfide, and combinations thereof; a catholyte in contact with the cathode, wherein the catholyte is not in contact with the anode; and an anolyte in contact with the anode, wherein the anolyte is not in contact with the cathode. The catholyte has a pH of less than 4, and the anolyte has a pH of greater than 10. The battery comprises a separator, wherein the separator has ion-selective properties.

### CROSS-REFERENCE TO RELATED APPLICATIONS

This application claims the benefit of U.S. Provisional Application No. 63/009,278 filed on Apr. 13, 2020 and entitled, “Metal-Free High Voltage Battery,” which is incorporated herein by reference in its entirety for all purposes.

### STATEMENT REGARDING GOVERNMENTALLY SPONSORED RESEARCH OR DEVELOPMENT

None.

### BACKGROUND

Energy storage systems like batteries are becoming increasingly important in the modern world. As countries are transitioning to greener economies, pairing renewable sources of energy with energy storage systems is becoming the norm. Batteries are not only getting used for grid storage applications, they are increasingly being used in more personal electronics and electric vehicles. As applications and markets (e.g., grid, electric vehicles, etc.) drive the size (physical and capacity (Ah)) of the batteries, the close association of batteries with consumers (e.g., personal electronics, electric cars, etc.) is also driving the need for batteries to be safer, non-toxic and non-flammable.

Metal-containing batteries are ubiquitous, and have long dominated the battery field having served several applications for over a century. Some of the notable examples are zinc, lead and lithium-anode batteries. Silver has been used as the cathode. Aluminum and magnesium are gaining traction as anode materials for the future of batteries; however, currently these batteries are highly unstable and suffer from very poor performance. Metals have usually been used as the anodes in batteries because of their ability to lose electrons easily. However, use of metallic electrodes in batteries present challenges in terms of safety, cost, performance, rechargeability, and long-term viability. Some metals like zinc and lead are relatively stable in aqueous electrolytes. However, aqueous electrolytes for some of the metal electrodes are not viable as their electrochemical activity is beyond the stability range of the electrolyte. For example, metals like lithium, aluminum and magnesium are highly reactive and unstable in aqueous electrolyte—which led to the development of organic electrolytes in batteries, but such organic electrolytes are flammable and moisture sensitive, thus making these types of batteries expensive to manufacture. A problem with metal anodes like zinc and lead is their tendency to dissociate water and form gases by splitting water to generate hydrogen and oxygen, which can present safety challenges. Similar problems are seen in lithium, aluminum and magnesium batteries as well; where lithium, aluminum and magnesium need organic electrolytes which are expensive, flammable and need controlled environments to handle them safely.

In terms of rechargeability, metal electrodes tend to form dendrites during repeated cycling, which can lead to penetration of the separator and shorting of the battery. This is dependent on the current density applied during charging of the battery, but nevertheless it is an issue in all metal anode systems which increase their chances of flammability and explosion. Metal electrodes also tend to passivate by forming an oxide or resistive coating during cycling which can lead to capacity decay and eventual failure of the battery. Corrosion and pitting of metals is another issue, which prevents its long term rechargeability. An ongoing need exists for batteries that are safe, non-flammable and non-toxic, while displaying a relatively wide working potential window.

### SUMMARY

In some embodiments, a high voltage metal-free battery comprises a cathode comprising a cathode electroactive material, wherein the cathode electroactive material comprises at least one of an organic compound, an oxide, a hydroxide, an oxyhydroxide, a sulfide, and combinations thereof; an anode comprising an anode electroactive material, wherein the anode electroactive material comprises at least one of an organic compound, an oxide, a hydroxide, an oxyhydroxide, a sulfide, and combinations thereof; a catholyte in contact with the cathode, wherein the catholyte is not in contact with the anode; an anolyte in contact with the anode, wherein the anolyte is not in contact with the cathode; and a separator disposed between the anolyte and the catholyte. The catholyte has a pH of less than 4, and the anolyte has a pH of greater than 10. The separator has ion-selective properties.

In some embodiments, a method of forming a high voltage metal-free battery comprises disposing a catholyte in contact with a cathode comprising a cathode electroactive material, wherein the cathode electroactive material comprises at least one of an organic compound, an oxide, a hydroxide, an oxyhydroxide, a sulfide, and combinations thereof; disposing an anolyte in contact with an anode comprising an anode electroactive material, wherein the anode electroactive material comprises at least one of an organic compound, an oxide, a hydroxide, an oxyhydroxide, a sulfide, and combinations thereof; and disposing a separator between the anolyte and the catholyte, wherein the catholyte is not in contact with the anode, and wherein the anolyte is not in contact with the cathode. The catholyte has a pH of less than 4, and the anolyte has a pH of greater than 10. The separator has ion-selective properties.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1A-1D illustrate schematic drawings of a high voltage metal-free battery according to some embodiments.

FIG. 2 illustrates a graph of voltage over time for a high voltage metal-free battery.

FIG. 3 illustrates a discharge curve of a high voltage metal-free battery in comparison with a MnO₀|Zn battery.

FIG. 4 illustrates discharge capacity curves of a high voltage metal-free battery.

FIG. 5 illustrates discharge capacity curves of a high voltage metal-free battery.

### DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused. As used herein, a “catholyte” refers to an electrolyte solution in contact with the cathode without being in direct contact with the anode, and an “anolyte” refers to an electrolyte solution in contact with the anode without being in direct contact with the cathode. The term electrolyte alone can refer to the catholyte, the anolyte, or an electrolyte in direct contact with both the anode and the cathode.

As used herein, a “metal-free battery” refers to a battery that is formed without the use of metal electroactive materials or metal electrodes (i.e., elemental or alloy metal electrodes), where the metal-free battery contains metal-free electrodes (e.g., where metal-free electrodes can comprise oxides, hydroxides, sulfides, and other salts of metals). The metal-free battery can also be referred to as a metal-free electrode battery, where the electroactive components of the electrode can be free of elemental or alloy metal even if another non-electroactive component such as a current collector (which does not take part in the reactions to generate a current) does contain element or alloy metals. Further, as used herein, the term “metal-free electrode” refers to an electrode that is formed from and contains materials other than metals in an oxidation state of 0. For example, Zn⁰ (Zn having an oxidation state of 0) may not be a suitable material for forming electrodes in a metal-free battery as disclosed herein. However, metals with an oxidation state other than 0 can be part of metal-free electrodes and metal-free batteries as disclosed herein, though in some embodiments a metal-free electrode may be paired with a metallic electrode. As another example, Mn⁴⁺ (Mn having an oxidation state of +4) is a suitable material for forming electrodes in a metal-free battery as disclosed herein, for example MnO₂ may be used a cathode material.

Energy storage systems like batteries are useful for a range of applications like grid-based, electric vehicles, solar storage, uninterruptible power sources, etc. Metal-containing batteries are ubiquitous, and have long dominated the battery field. However, use of metallic electrodes in batteries present challenges in terms of safety, cost, performance, rechargeability, and long-term viability.

The development of metal-free batteries would solve several of the issues that are present in metal-based batteries. However, the voltage or potential of the battery is dependent on both the cathode and the anode, and the capability of the anode to lose electrons, at which metal-based electrodes are apt. In a single electrolyte system, it is not possible to pair different metal oxides or sulfides like manganese dioxide (MnO₂), hausmannite (Mn₃O₄), nickel hydroxide [Ni(OH)₂], nickel oxyhydroxide (NiOOH), etc. as they readily accept electrons and tend to behave more like cathodes. Further, the voltage generated between these promising electrode active materials would be negligible.

In this disclosure, a metal-free dual electrolyte battery is disclosed, wherein the battery has relatively high voltage, relatively high capacity and, if desired, rechargeable characteristics. Nonlimiting examples of battery chemistries suitable for use in the present disclosure in a metal-free battery include manganese dioxide (MnO₂)|manganese dioxide (MnO₂), MnO₂|bixbyite (Mn₂O₃), MnO₂|hausmannite (Mn₃O₄), MnO₂|manganese oxide (MnO), MnO₂|pyrochroite [Mn(OH)₂], MnO₂|manganese oxyhydroxide (MnOOH), MnO₂|nickel oxyhydroxide (NiOOH), MnO₂|nickel hydroxide [Ni(OH)₂], MnO₂|iron oxide (Fe₂O₃), MnO₂|iron oxide (Fe₃O₄), MnO₂|copper oxide (Cu₂O, CuO), MnO₂|copper hydroxide [Cu(OH)₂], MnO₂|cobalt oxide (Co₃O₄), NiOOH|NiOOH, NiOOH|Ni(OH)₂, nickel oxide (Ni₂O₃)|NiOOH, Ni₂O₃|Ni(OH)₂, nickel oxide (NiO)|NiOOH, NiO|Ni(OH)₂, nickel oxide(Ni₂O₃, NiO)|copper oxide (CuO,Cu₂O), or any combination thereof. The anode and cathode in these systems can be interchanged. The use of a dual electrolyte where an electrolyte with high proton activity like acids and electrolyte with high hydroxyl activity like bases can allow these systems to generate a working voltage. For example, a battery created with MnO₂|MnO₂ with concentrated acid (catholyte) and base (anolyte) can generated a potential greater than about 2 V. As an example, disclosed herein is a single redox active element (Mn) chemistry where its oxides are paired in high voltage aqueous batteries that can outperform a conventional alkaline MnO₂|zinc (Zn) battery in terms of energy (voltage×capacity) and rechargeability.

In this disclosure, a method of making a metal-free battery by employing new battery chemistries and dual electrolytes is disclosed, wherein the new battery chemistries may comprise manganese dioxide (MnO₂)|manganese dioxide (MnO₂), MnO₂|bixbyite (Mn₂O₃), MnO₂|hausmannite (Mn₃O₄), MnO₂|pyrochroite [Mn(OH)₂], MnO₂|manganese oxyhydroxide (MnOOH), MnO₂|nickel oxyhydroxide (NiOOH), MnO₂|nickel hydroxide [Ni(OH)₂], MnO₂|iron oxide (Fe₂O₃), MnO₂|iron oxide (Fe₃O₄), MnO₂|copper oxide (Cu₂O, CuO), MnO₂|copper hydroxide [Cu(OH)₂], MnO₂ cobalt oxide (Co₃O₄), NiOOH|NiOOH, NiOOH|Ni(OH)₂, nickel oxide (Ni₂O₃)|NiOOH, Ni₂O₃|Ni(OH)₂, nickel oxide (NiO)|NiOOH, NiO|Ni(OH)₂, nickel oxide (Ni₂O₃, NiO)|copper oxide (CuO,Cu₂O), or any combination thereof; wherein the battery comprises dual electrolytes; and wherein one of the electrodes is in an electrolyte of high proton activity (e.g., acids) and the other electrode is in an electrolyte of high hydroxyl activity (e.g., bases). For example, when the battery is based on a chemistry such as MnO₂|NiOOH, either of the electrodes can be in acid or bases, thus all the chemistry systems mentioned above (e.g., new battery chemistries) could act like cathodes and anodes with positive voltages depending on their standard electrochemical reactions in the respective medium (e.g., standard electrochemical reaction in acidic medium, standard electrochemical reaction in basic medium). This splitting or decoupling of electrolytes of different activities, several novel battery chemistries are disclosed herein, which battery chemistries were not feasible before for practical use in batteries. The novel battery chemistries as disclosed herein advantageously open the production of batteries that are single redox active elements that operate through conversion reactions in dual electrolyte systems. The electrode pairings as disclosed herein (e.g., new battery chemistries) have never been tried or reported before in patent or academic literature.

In this disclosure, a metal-free battery may be based on a single redox active element (manganese), where its oxides can be paired together as cathodes and anodes to generate a high voltage aqueous battery. In some aspects, this metal-free battery as disclosed herein can outperform a conventional alkaline MnO₂|Zn battery in terms of voltage, capacity and rechargeability. Nonlimiting examples of electrode systems of the single redox active manganese element and its oxides suitable for use in the present disclosure include MnO₂|MnO₂ and/or MnO₂|Mn₃O₄. Further nonlimiting examples of electrode systems suitable for use in the present disclosure include the new battery chemistries as disclosed herein based on single redox active elements other than Mn (e.g., Ni, Fe, Cu, Ag, etc.) and/or their organic compounds, oxides, hydroxides, oxyhydroxides, and/or sulfides.

In some embodiments, the electrode electroactive material (e.g., anode electroactive material, cathode electroactive material) suitable for use in the electrodes of the high voltage metal-free battery as disclosed herein may comprise manganese dioxide (MnO₂), wherein the MnO₂ can be of any polymorph that exists in nature or that can be in made in the lab. Nonlimiting examples of (MnO₂ suitable for use in the metal-free electrodes as disclosed herein include electrolytic manganese dioxide (EMD), α-MnO₂, β-MnO₂, γ-MnO₂, δ-MnO₂, ε-MnO₂, λ-MnO₂, or any combination thereof. Other forms of MnO₂ can also be present in the metal-free electrodes as disclosed herein, such as pyrolusite, birnessite, bismuth-birnessite, copper intercalated bismuth-birnessite, copper intercalated birnessite. ramsdellite, hollandite, romanechite, todorokite, lithiophorite, chalcophanite, sodium or potassium rich birnessite, cryptomelane, buserite, partially or fully protonated manganese dioxide, lithiated manganese dioxide, and the like, or any combination thereof. As disclosed herein, “manganese dioxide (MnO₂)” is understood to encompass any suitable polymorph that exists in nature or that can be in made in the lab, as well as any mixed oxides and/or minerals containing manganese dioxide, such as EMD, α-MnO₂, β-MnO₂, γ-MnO₂, δ-MnO₂, ε-MnO₂, λ-MnO₂, pyrolusite, birnessite, bismuth-birnessite, copper intercalated bismuth-birnessite, copper intercalated birnessite. ramsdellite, hollandite, romanechite, todorokite, lithiophorite, chalcophanite, sodium or potassium rich birnessite, cryptomelane, buserite, partially or fully protonated manganese dioxide, lithiated manganese dioxide, and the like, or any combination thereof. Without wishing to be limited by theory, the mechanism through which a battery like MnO₂|MnO₂ would operate is through a solid-state proton insertion and a dissolution-precipitation reaction in both acid and base electrolytes. The MnO₂ in acid medium would tend to form electrolytic manganese dioxide or γ-MnO₂ on charge through its one or two electron reactions, while the MnO₂ in base electrolyte would convert itself to a δ-MnO₂ on charge after successive one or two electron reactions. γ-MnO₂ undergoes a solid-state proton insertion for its first electron reaction and a dissolution-precipitation reaction for its second electron reaction in both mediums, while the γ-MnO₂ in base electrolyte would eventually convert to δ-MnO₂. γ-MnO₂ in acid medium can undergo direct dissolution-precipitation reactions as well depending on the strength of the acid used. Therefore, creating batteries of γ-MnO₂|γ-MnO₂ and γ-MnO₂|δ-MnO₂ can operate through a wide range of chemical reactions. A γ-MnO₂|Mn₃O₄ battery can have γ-MnO₂ operating in an acidic electrolyte while the Mn₃O₄ is operating in an alkaline electrolyte, and this battery operation could have the electrolytes interchanged, for example with γ-MnO₂ in base and Mn₃O₄ in acid. In the case of γ-MnO₂ in acid, it would follow the proton-insertion and dissolution-precipitation or only dissolution-precipitation depending on the strength of the acid, while Mn₃O₄ would directly follow the dissolution-precipitation reactions.

Rechargeable characteristics of the metal-free battery as disclosed herein can be obtained by the addition of dopants or additives to the electrodes and/or electrolytes. In some embodiments, electrode additives can help increase the rechargeability of metal-free battery as disclosed herein. Irrespective of the electroactive redox element (e.g., Mn, Ni, Cu, Fe, Ag, etc.) and its compounds (e.g., oxide, hydroxide, oxyhydroxide, sulfide, organic compound) that are used in the metal-free battery, the electrode additives disclosed herein can be used for both the cathode and the anode materials. Nonlimiting examples of electrode additives suitable for use in the metal-free electrodes of the present disclosure include bismuth oxide, indium oxide, indium hydroxide, copper oxide, aluminum oxide, lead oxide, lead sulfide, bismuth sulfide, silver oxide, nickel oxide, nickel hydroxide, cobalt oxide, or any combination thereof.

The separation of electrolytes of varying pH can be important to prevent any neutralization reactions from taking place. In some embodiments, the separation of electrolytes can be achieved by gelling the electrolytes which physically prevents them from mixing. Use of crosslinkers and ionomers in the gelling process can also prevent the crossover of ions, which would allow for the use of cellulose-based separators like cellophane and polymer-based separators like polyvinyl alcohol or cross-linked polyvinyl alcohol. The electrolyte gelling process can be done through the use of free radical polymerization process. Acrylamides and acrylic acids can be made into long polymer chains by mixing with either electrolytes of high proton or hydroxyl activity. Crosslinkers like N,N′-methylenebisacrylamide (MBA) can be used to increase the strength of the polymers and make it more viscous and impart it self-healing properties. The gelling or polymerization of electrolytes can be conducted with the use of initiators like potassium or sodium or ammonium persulfate. In some embodiments, preventing the mixing of the electrolytes can be achieved by using ion selective ceramic separators or membranes like LiSiCON, NaSiCON, Nafion membranes, anion-exchange membranes, bipolar membranes, or any combination thereof.

An advantage of having a dual electrolyte cell with relatively high proton activity in the catholyte on the cathode side and relatively high hydroxyl activity in the anolyte on the anode side is an increase in cell potential. A relatively high proton activity on the cathode side and a relatively high hydroxyl activity on the anode side can increase the cell potential, which in turn can lead to higher average discharge voltages and thus, higher energy from the cell.

Another advantage of decoupling the electrolytes used for the cathode and anode is generating a positive voltage and cyclability of the novel battery chemistries disclosed herein. Acids are generally preferred for the cathodes, while bases are preferred for the anodes. The electrolytes can interchange for the cathodes and anodes. Nonlimiting examples of acids suitable for use in the metal-free batteries of the present disclosure include hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, or any combination thereof. Nonlimiting examples of bases suitable for use in the metal-free batteries of the present disclosure include ammonia, methylamine, glycine, lithium hydroxide, sodium hydroxide, potassium hydroxide, caesium hydroxide, rubidium hydroxide, calcium hydroxide, strontium hydroxide, barium hydroxide, or any combination thereof.

In some embodiments, electrolyte additives can also help boost performance of the battery. Nonlimiting examples of electrolyte additives suitable for use in the metal-free batteries of the present disclosure include manganese sulfate, nickel sulfate, potassium permanganate, manganese chloride, manganese acetate, manganese triflate, bismuth chloride, bismuth nitrate, manganese nitrate, nickel sulfate, nickel nitrate, zinc sulfate, zinc chloride, zinc acetate, zinc triflate, indium chloride, copper sulfate, copper chloride, lead sulfate, sodium persulfate, potassium persulfate, ammonium persulfate, ammonium chloride, vanillin, sodium hypophosphate, potassium chloride, sodium chloride, or any combination thereof.

In some embodiments, the electrolytes can be gelled with their corresponding additive, which helps to physically separate the electrolytes and prevent electrolyte neutralization. The gelling or polymerization of the electrolytes can be done through various techniques, such as via free radical polymerization. Acrylamides and acrylic acids can be made into long polymer chains by mixing with either electrolytes of relatively high proton activity or relatively high hydroxyl activity. Crosslinkers like MBA can be used to increase the strength of the polymers and make the polymer more viscous, as well as impart self-healing properties to the polymer. The gelling or polymerization can be conducted with the use of initiators like potassium or sodium or ammonium persulfate.

The separation of the electrolytes could be achieved by using any suitable methodology. For example, a gel layer embedded with ionomers with ion-selective properties can act as a barrier layer to prevent cross-over of neutralizing ions. The gelling procedure can be done via free radical polymerization as disclosed herein. Buffering additives can be added to the gelled ionomer, wherein the buffering additives may comprise potassium sulfate, sodium sulfate, potassium bicarbonate, sodium bicarbonate, and the like, or any combination thereof. Ion selective ceramic separators or membranes like LiSiCON, NaSiCON, Nafion membranes, anion-exchange membranes, bipolar membranes, etc. can also be used to achieve electrolyte separation.

Disclosed herein is a high voltage metal-free battery utilizing dual electrolytes to generate high voltages and capacities of the corresponding electrodes. For the first time novel electrode pairings are presented, wherein such electrode pairings advantageously display added battery benefits of safety, non-toxicity and non-flammability. For the first time in patent and academic literature, a single redox active element pairing is disclosed, wherein this novel electrode chemistry pairing displays conversion characteristics in dual electrolytes that advantageously increase the energy density of the battery.

Disclosed herein is a high voltage metal-free battery that can deliver its average discharge capacity between greater than 1.6 V and 5 V with an operational range between 0 and 5 V, where the battery has both single use and rechargeable characteristics.

In this disclosure, a metal-free high voltage aqueous battery is disclosed. In this disclosure, the high voltage metal-free battery may be characterized by an average discharge potential between greater than 1.6 V and 5 V. A conventional alkaline MnO₂|Zn battery has an average discharge potential of 1.6 V. The high voltage metal-free battery as disclosed herein can be discharged one time or can have rechargeable characteristics depending on the use of dopants or additives in the electrodes or electrolytes. The high voltage metal-free battery as disclosed herein can be of single use or can be made rechargeable. The electrode pairings in this system can be of single redox active element oxides, hydroxides, oxyhydroxides, sulfides, organic compounds, or any combination thereof; and/or a pairing of various oxides, hydroxides, oxyhydroxides, sulfides, or any combination thereof which retain their oxides, hydroxides, oxyhydroxides, sulfides, organic compounds, or any combination thereof structure, respectively during charging and discharging. Without wishing to be limited by theory, the capacity obtained could be through a mechanism of ion insertion or intercalation and/or dissolution-precipitation reactions. The relatively high discharge potential can be achieved through decoupling of electrolytes with different strengths related to hydrogen (or proton) and hydroxyl activity. In some embodiments, long term rechargeability of the high voltage metal-free battery can be obtained through the use of additives and/or dopants. Separation of the anolyte and catholyte can also be obtained by the use of ion-selective ceramic and/or polymeric membranes. In some cases, separation could be achieved through use of gelation of electrolytes with ion-selective ionomers embedded in them to prevent any neutralization by ion-migration. Further, gelled separators that act as buffering layers containing ion-selective ionomers and buffering agents may be employed to separate the anolyte from the catholyte. Nonlimiting examples of buffering agents suitable for use in the buffering layers of the present disclosure include potassium carbonate, potassium bicarbonate, sodium carbonate, sodium bicarbonate, or any combination thereof.

In this disclosure, the high voltage metal-free battery can be made of any geometric form factor if desired. To those skilled in the art, the high voltage aqueous Zn-anode battery can be cylindrical or prismatic. Further, the high voltage metal-free battery can also be made flexible if desired by gelling of electrolytes and electrodes or by using binders in electrodes that allow for flexibility.

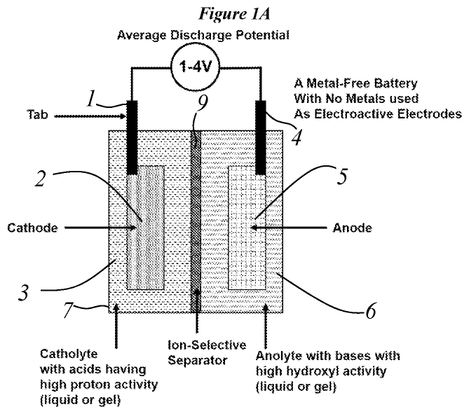

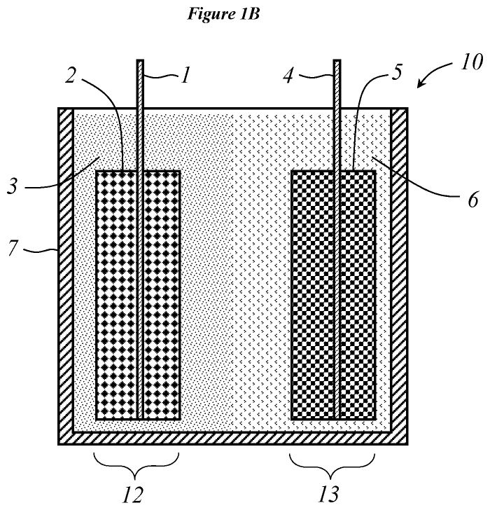

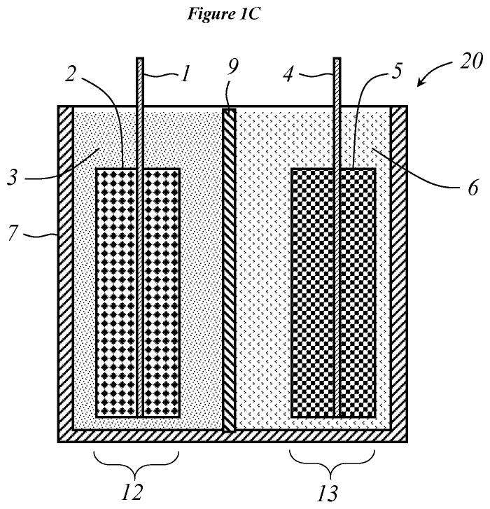

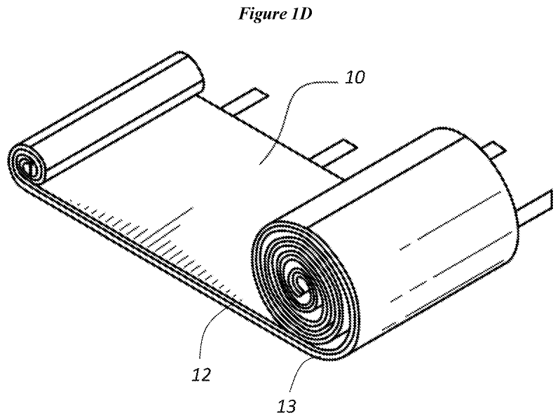

Referring to FIGS. 1A-1D, a battery 10 can have a housing 7, a cathode 12, which can include a cathode current collector 1 and a cathode material 2, and an anode 13. In some embodiments, the anode 13 can comprise an anode current collector 4, and an anode material 5. It is noted that the scale of the components in FIGS. 1A-1D may not be exact as the features are illustrates to clearly show the electrolyte around the anode 13 and the cathode 12. FIGS. 1A-1C show a prismatic battery arrangement having a single anode 13 and cathode 12. In another embodiment, the battery can be a cylindrical battery (e.g., as shown in FIG. 1D) having the electrodes arranged concentrically or in a rolled configuration in which the anode and cathode are layered and then rolled to form a jelly roll configuration. The cathode current collector 1 and cathode material 2 are collectively called either the cathode 12 or the positive electrode 12, as shown in FIG. 1D. Similarly, the anode material 5 with the optional anode current collector 4 can be collectively called either the anode 13 or the negative electrode 13. An electrolyte can be in contact with the cathode 12 and the anode 13. As described in more detail herein, the electrolyte in contact with both the cathode 12 and the anode 13 can be substantially the same with different concentrations of protons and hydroxyl ions, or alternatively, different electrolyte compositions can be used with the anode 13 and the cathode 12 to modify the properties of the battery 10 in some embodiments.

In some embodiments, the battery 10 can comprise one or more cathodes 12 and one or more anodes 13, which can be present in any configuration or form factor. When a plurality of anodes 13 and/or a plurality of cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jellyroll configuration (e.g., as shown in FIG. 1D), the battery 10 may only have one cathode 12 and one anode 13 in a rolled configuration such that a cross section of the battery 10 includes a layered configuration of alternating electrodes, though a plurality of cathodes 12 and anodes 13 can be used in a layered configuration and rolled to form the rolled configuration with alternating layers.

In an embodiment, housing 7 comprises a molded box or container that is generally non-reactive with respect to the electrolyte solutions in the battery 10, including the electrolyte. In an embodiment, the housing 7 comprises a polymer (e.g., a polypropylene molded box, an acrylic polymer molded box, etc.), a coated metal, or the like.

The cathode 12 can comprise a mixture of components including an electrochemically active material (e.g., cathode electroactive material). The anode 13 can comprise a mixture of components including an electrochemically active material (e.g., anode electroactive material). As disclosed herein, the metal-free battery may have metal-free cathode electroactive material and metal free anode electroactive material, though metal may be present in other parts of the battery. Additional components such as a binder, a conductive material, and/or one or more additional components can also be optionally included that can serve to improve the lifespan, rechargeability, and electrochemical properties of the metal-free electrodes (e.g., cathode 12, anode 13). The cathode 12 can comprise a cathode material 2 (e.g., an electroactive material, additives, etc.). The cathode 12 can comprise between about 1 wt. % and about 95 wt. % active material. The anode 13 can comprise an anode material 5 (e.g., an electroactive material, additives, etc.). The anode 13 can comprise between about 1 wt. % and about 95 wt. % active material.

The high voltage metal-free battery as disclosed herein comprises metal-free electrodes, such as a metal-free cathode 12 and a metal-free anode 13. In some aspects, the electroactive material in each electrode may be metal free even if metal exists in other parts of the electrodes or battery. The cathode 12 and anode 13 pairings can be a combination of any of the electrode materials disclosed herein, wherein the electrode materials may be present as an organic compound, an oxide, hydroxide, oxyhydroxide, and/or sulfide.

Suitable electrode materials (e.g., cathode materials 2, anode materials 5) can include, but are not limited to, manganese dioxide, copper manganese oxide, hausmannite, manganese oxide, copper intercalated bismuth birnessite, birnessite, todokorite, ramsdellite, pyrolusite, pyrochroite, silver compounds, silver oxide, silver dioxide, nickel compounds, nickel organic compound, nickel oxyhydroxide, nickel hydroxide, lead oxide, copper oxide, copper dioxide, lead compounds, lead dioxide (α and β), potassium persulfate, sodium persulfate, ammonium persulfate, potassium permanganate, calcium permanganate, barium permanganate, silver permanganate, ammonium permanganate, peroxide, gold compounds, perchlorate, cobalt oxide (CoO, CoO₂, Co₃O₄), lithium cobalt oxide, sodium cobalt oxide, perchlorate, nickel oxide, Mn₃O₄, hetaerolite (ZnMn₂O₄), barium hydroxide, aluminum hydroxide, bromine, mercury compounds, vanadium oxide, bismuth vanadium oxide, hydroquinone, calix[4]quinone, tetrachlorobenzoquinone, 1,4-naphthoquinone, 9,10-anthraquinone, 1,2-napthaquinone, 9,10-phenanthrenequinone, nitroxide-oxammonium cation redox pair like 2,2,6,6-tetramethylpiperidin-1-yl)oxyl (TEMPO), carbon, 2,3-dicyano-5,6-dichlorodicyanoquinone, tetracyanoethylene, sulfur trioxide, ozone, oxygen, air, lithium nickel manganese cobalt oxide, sulfur, lithium iron phosphate, lithium copper oxide, lithium copper oxyphosphate, or any combination thereof. In some embodiments, the cathode can comprise an air electrode.

In some embodiments, the electrode material (e.g., cathode material 2, anode material 5) can be based on one or many polymorphs of MnO₂, including electrolytic manganese dioxide (EMD), α-MnO₂, β-MnO₂, γ-MnO₂, δ-MnO₂, ε-MnO₂, or λ-MnO₂. Other forms of MnO₂ can also be present such as hydrated MnO₂, pyrolusite, birnessite, ramsdellite, hollandite, romanechite, todorokite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄, Li₂MnO₃), CuMn₂O₄, aluminum manganese oxide, zinc manganese dioxide, bismuth manganese oxide, copper intercalated birnessite, copper intercalated bismuth birnessite, tin doped manganese oxide, magnesium manganese oxide, or any combination thereof. In general, the cycled form of manganese dioxide in the electrode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

In some embodiments, the electrode materials (e.g., cathode materials 2, anode materials 5) suitable for use in the high voltage metal-free battery disclosed herein may comprise electrolytic manganese dioxide (EMD), α-MnO₂, β-MnO₂, γ-MnO₂, δ-MnO₂, ε-MnO₂, λ-MnO₂, or any combination thereof. Other forms of MnO₂ can also be present in the electrode materials, such as pyrolusite, birnessite, ramsdellite, hollandite, romanechite, todorokite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄), CuMn₂O₄, zinc manganese dioxide, or any combination thereof. Nonlimiting examples of electrode materials (e.g., cathode materials 2, anode materials 5) suitable for use in the high voltage metal-free battery disclosed herein include electrolytic manganese dioxide (EMD), α-MnO₂, β-MnO₂, γ-MnO₂, δ-MnO₂, ε-MnO₂, λ-MnO₂, pyrolusite, birnessite, ramsdellite, hollandite, romanechite, todorokite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄), CuMn₂O₄, zinc manganese dioxide, lead oxide, lead dioxide, copper oxide, copper hydroxide, silver oxide, nickel oxide, nickel hydroxide, nickel oxyhydroxide, cobalt oxide, cobalt hydroxide, lithium nickel manganese cobalt oxide, lithium nickel oxide, lithium manganese oxide, lithium cobalt oxide, lithium iron phosphate, potassium iron oxide, barium iron oxide, copper hexacyanoferrate, delithiated manganese oxides, delithiated nickel oxides, delithiated nickle manganese oxides, delithiated nickel manganese cobalt oxides, iron oxide, iron hydroxides, tin oxide, tin sulfide, manganese sulfide, nickel sulfide, copper sulfide, tungsten oxide, tungsten disulfide, calix[4]quinone, 1,4-napththoquinone, 9,10-anthraquinone, vanadium oxide, or any combination thereof.

The cells as described herein can be formed by pairing of any of the cathode materials described herein and any of the anode materials as described to the extent that the materials mentioned above may generate a voltage in the presence of suitable electrolytes (e.g., a suitable anolyte and catholyte, etc.).

In some embodiments, the cathode 12 used in the high voltage metal-free battery as disclosed herein can contain electroactive materials like metal oxides, metal hydroxides, metal oxyhydroxides, metal salts (e.g., metal sulfides), organic compounds, etc. that have electrochemical activity in electrolytes of high proton activity, such as in the catholyte 3.

In some embodiments, the anode 13 used in the high voltage metal-free battery as disclosed herein can contain electroactive materials like metal oxides, metal hydroxides, metal oxyhydroxides, metal salts (e.g., metal sulfides), organic compounds, etc. that have electrochemical activity in electrolytes of high hydroxyl activity, such as in the anolyte 6.

Nonlimiting examples of electrode materials (e.g., cathode materials 2, anode materials 5) that have electrochemical activity in electrolytes of high proton activity or high hydroxyl activity include electrolytic manganese dioxide (EMD), α-MnO₂, β-MnO₂, γ-MnO₂, δ-MnO₂, ε-MnO₂, λ-MnO₂, or any combination thereof. Other forms of MnO₂ can also be present in the electrodes (e.g., cathode 12, anode 13), such as pyrolusite, birnessite, ramsdellite, hollandite, romanechite, todorokite, lithiophorite, chalcophanite, sodium rich birnessite, potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄), CuMn₂O₄, zinc manganese dioxide, lead oxide, lead, lead dioxide, copper compounds, copper oxide, copper hydroxide, silver compounds, silver oxide, nickel compounds, nickel oxide, nickel hydroxide, nickel oxyhydroxide, cobalt oxide, cobalt compounds, cobalt hydroxide, lithium nickel manganese cobalt oxide, lithium nickel oxide, lithium manganese oxide, lithium cobalt oxide, lithium iron phosphate, potassium iron oxide, barium iron oxide, copper hexacyanoferrate, delithiated manganese oxides, delithiated nickel oxides, delithiated nickel manganese oxides, delithiated nickel manganese cobalt oxides, quinone compounds like calix[4]quinone, 1,4-napththoquinone, 9,10-anthraquinone, or any combination thereof. Combinations of electroactive materials can also be employed in the electrode materials (e.g., cathode materials 2, anode materials 5). The electroactive electrode materials (e.g., electroactive cathode materials 2, electroactive anode materials 5) can be in the form of powders of varying particle sizes (nanometers to micrometers).

Examples of battery systems suitable for use in the high voltage metal-free battery disclosed herein can include manganese dioxide (MnO₂)|manganese dioxide (MnO₂), MnO₂|bixbyite (Mn₂O₃), MnO₂|hausmannite (Mn₃O₄), MnO₂|pyrochroite [Mn(OH)₂], MnO₂|manganese oxyhydroxide (MnOOH), MnO₂|manganese oxide (MnO), MnO₂|nickel oxyhydroxide (NiOOH), MnO₂|nickel hydroxide [Ni(OH)₂], MnO₂|iron oxide (Fe₂O₃), MnO₂|iron oxide (Fe₃O₄), MnO₂|copper oxide (Cu₂O, CuO), MnO₂|copper hydroxide [Cu(OH)₂], MnO₂|cobalt oxide (Co₃O₄), NiOOH|NiOOH, NiOOH|NKOH)₂, nickel oxide (Ni₂O₃)|NiOOH, Ni₂O₃|Ni(OH)₂, nickel oxide (NiO)|NiOOH, NiO|Ni(OH)₂, nickel oxide (Ni₂O₃, NiO)|copper oxide (CuO,Cu₂O), or any combination thereof. The MnO₂, NiOOH, etc. can exist in their various polymorphic forms when paired in these battery systems.

The cathode electroactive material and/or the anode electroactive material may need to be mixed with conductive additives, such as carbon. The addition of a conductive additive such as conductive carbon enables high loadings of an electroactive material in the electrode material (e.g., cathode material 2, anode material 5), resulting in high volumetric and gravimetric energy density. In some embodiments, the conductive additive can be present in the electrode material (e.g., cathode material 2, anode material 5) in an amount of about 1-30 wt. %, based on the total weight of the electrode material (e.g., cathode material 2, anode material 5). In some embodiments, the conductive additive can comprise graphite, carbon fiber, carbon black, acetylene black, single walled carbon nanotubes, multi-walled carbon nanotubes, dispersions of single walled carbon nanotubes, dispersions of multi-walled carbon nanotubes, graphene, graphyne, graphene oxide, or a combination thereof. Higher loadings of the electroactive material in the electrode (e.g., cathode 12, anode 13) are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family), TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), Zenyatta graphite, and/or combinations thereof.

In some embodiments, the conductive additive can have a particle size range from about 1 to about 50 microns, or between about 2 and about 30 microns, or between about 5 and about 15 microns. In an embodiment, the conductive additive can include expanded graphite having a particle size range from about 10 to about 50 microns, or from about 20 to about 30 microns. Carbon fibers and nanotubes can have varying aspect ratios where their diameters can be in the tens to hundreds of nanometers. In some embodiments, the mass ratio of graphite to the conductive additive can range from about 5:1 to about 50:1, or from about 7:1 to about 28:1. The total conductive additive mass percentage (e.g., total carbon mass percentage) in the electrode material (e.g., cathode material 2, anode material 5) can range from about 5% to about 99%, or from about 10% to about 80%. In some embodiments, the electroactive component in the electrode material (e.g., cathode material 2, anode material 5) can be between 1 and 99 wt. % of the weight of the electrode material (e.g., cathode material 2, anode material 5), and the conductive additive can be between 1 and 99 wt. % of the weight of the electrode material (e.g., cathode material 2, anode material 5).

In some embodiments, dopants or additives can be added to the electrode material (e.g., cathode material 2, anode material 5), to enhance rechargeability and performance. The additives can be in the form of powders mixed with the electroactive material or in the form of substrates onto which the electroactive and conductive carbon can be pasted onto. Nonlimiting examples of additives suitable for use in the electrode material (e.g., cathode material 2, anode material 5) of this disclosure include bismuth compounds, bismuth oxide, copper oxide, copper compounds, indium compounds, indium hydroxide, indium oxide, aluminum compounds, aluminum oxide, nickel compounds, nickel hydroxide, nickel oxide, silver compounds, silver oxide, cobalt compounds, cobalt oxide, cobalt hydroxide, lead compounds, lead oxide, lead dioxide, quinones, salts thereof, derivatives thereof, or any combination thereof. In some embodiments, the dopants or additives can be present in the electrode material (e.g., cathode material 2, anode material 5) in an amount between 0 to 30 wt. %, based on the total weight of the electrode material (e.g., cathode material 2, anode material 5).

In some embodiments, the electrode material (e.g., cathode material 2, anode material 5) can also comprise a conductive component. The addition of a conductive component to the electrode material (e.g., cathode material 2, anode material 5) may be accomplished by addition of conductive component powders to the electrode material (e.g., cathode material 2, anode material 5). The conductive component can be present in a concentration of between about 0-30 wt. % in the electrode material (e.g., cathode material 2, anode material 5). The conductive component may be, for example, an oxide, a salt, and/or a hydroxide of one or more metals selected from the group consisting of nickel, copper, silver, gold, tin, cobalt, antimony, brass, bronze, aluminum, calcium, iron, platinum, and any combinations thereof. In one embodiment, the conductive component is a powder. In some embodiments, the conductive component can be added as an oxide powder, a salt powder, a hydroxide powder, or a combination thereof. In some embodiments, the conductive component can be cobalt oxide, cobalt hydroxide, lead oxide, lead hydroxide, or a combination thereof. In some embodiments, a second conductive component can be added to act as a supportive conductive backbone for the first and second electron reactions to take place. The second electron reaction has a dissolution-precipitation reaction where Mn₃₊ ions become soluble in the electrolyte and precipitate out on the materials such as graphite resulting in an electrochemical reaction and the formation of manganese hydroxide [Mn(OH)₂] which is non-conductive. This ultimately results in a capacity fade in subsequent cycles. Suitable conductive components that can help to reduce the solubility of the manganese ions include oxides, salts, and/or hydroxides of transition metals like Ni, Co, Fe, Ti, and/or oxides, salts, and/or hydroxides of metals like Ag, Au, Al, Ca. Oxides, salts, and/or hydroxides of transition metals like Co can also help in reducing the solubility of Mn³⁺ ions. Such conductive components may be incorporated into the electrode (e.g., cathode 12, anode 13) by chemical means or by physical means (e.g. ball milling, mortar/pestle, spex mixture). An example of such an electrode (e.g., cathode 12, anode 13) comprises 5-95% birnessite, 5-95% conductive carbon, 0-50% conductive component, and 1-10% binder.

In some embodiments, a binder can be used with the electrode material (e.g., cathode material 2, anode material 5). The binder can be present in a concentration of between about 0-10 wt. %, or alternatively between about 1-5 wt. % by weight of the electrode material (e.g., cathode material 2, anode material 5). In some embodiments, the binder comprises water-soluble cellulose-based hydrogels, which can be used as thickeners and strong binders, and have been cross-linked with good mechanical strength and with conductive polymers. The binder may also be a cellulose film sold as cellophane. The binders can be made by physically cross-linking the water-soluble cellulose-based hydrogels with a polymer through repeated cooling and thawing cycles. In some embodiments, the binder can comprise a 0-10 wt. % carboxymethyl cellulose (CMC) solution cross-linked with 0-10 wt. % polyvinyl alcohol (PVA) on an equal volume basis. The binder, compared to the traditionally-used TEFLON® or PTFE (polytetrafluoroethylene), shows superior performance. TEFLON® or PTFE is a very resistive material, but its use in the industry has been widespread due to its good rollable properties. This, however, does not rule out using TEFLON® or PTFE as a binder. Mixtures of TEFLON® or PTFE with the aqueous binder and some conductive carbon can be used to create rollable binders. Using the aqueous-based binder can help in achieving a significant fraction of the two-electron capacity with minimal capacity loss over many cycles. In some embodiments, the binder can be water-based, have superior water retention capabilities, adhesion properties, and help to maintain the conductivity relative to an identical cathode using a PTFE binder instead. Examples of suitable water-based hydrogels can include, but are not limited to, methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), and combinations thereof. Examples of crosslinking polymers include polyvinyl alcohol, polyvinylacetate, polyaniline, polyvinylpyrrolidone, polyvinylidene fluoride, polypyrrole, and combinations thereof. In some embodiments, a 0-10 wt. % solution of water-cased cellulose hydrogen can be cross-linked with a 0-10 wt. % solution of crosslinking polymers by, for example, repeated freeze/thaw cycles, radiation treatment, and/or chemical agents (e.g., epichlorohydrin). The aqueous binder may be mixed with 0-5% PTFE to improve manufacturability.

The electrode material (e.g., cathode material 2, anode material 5) can also comprise additional elements. The additional elements can be included in the electrode material (e.g., cathode material 2, anode material 5) including a bismuth compound and/or a copper compound, which together allow improved galvanostatic battery cycling of the cathode. When present as birnessite, the copper and/or bismuth compounds can be incorporated into the layered nanostructure of the birnessite. The resulting birnessite electrode material (e.g., cathode material 2, anode material 5) can exhibit improved cycling and long-term performance with the copper and/or bismuth compounds incorporated into the crystal and nanostructure of the birnessite.

The bismuth compound can be incorporated into the cathode 12 as an inorganic or organic salt of bismuth (oxidation states 5, 4, 3, 2, or 1), or as a bismuth oxide. The bismuth compound can be present in the electrode material (e.g., cathode material 2, anode material 5) at a concentration between about 1-20 wt. % of the weight of the electrode material (e.g., cathode material 2, anode material 5). Examples of bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yttria stabilized (e.g., yttria doped bismuth oxide), bismuth-lead alloy, ammonium bismuth citrate, 2-napthol bismuth salt, dichloritri(o-tolyl)bismuth, dichlorodiphenyl(p-tolyl)bismuth, triphenylbismuth, and/or combinations thereof.

The copper compound can be incorporated into the electrode (e.g., cathode 12, anode 13) as an organic or inorganic salt of copper (oxidation states 1, 2, 3, or 4), or as a copper oxide. The copper compound can be present in a concentration between about 1-70 wt. % of the weight of the electrode material (e.g., cathode material 2, anode material 5). In some embodiments, the copper compound is present in a concentration between about 5-50 wt. % of the weight of the electrode material (e.g., cathode material 2, anode material 5). In other embodiments, the copper compound is present in a concentration between about 10-50 wt. % of the weight of the electrode material (e.g., cathode material 2, anode material 5). In yet other embodiments, the copper compound is present in a concentration between about 5-20 wt. % of the weight of the electrode material (e.g., cathode material 2, anode material 5). Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper compounds is to alter the oxidation and reduction voltages of bismuth compounds. This results in an electrode (e.g., cathode 12, anode 13) with full reversibility during galvanostatic cycling, as compared to a bismuth-modified MnO₂ which cannot withstand galvanostatic cycling as well.

The electrodes (e.g., cathodes 12, anodes 13) can be produced using methods implementable in large-scale manufacturing. In some embodiments, the electrode material (e.g., cathode material 2, anode material 5) can comprises 2-30 wt. % conductive carbon, 0-30 wt. % conductive additive, 1-70 wt. % copper compound, 1-20 wt. % bismuth compound, 0-10 wt. % binder and birnessite or EMD. In another embodiment, the electrode material (e.g., cathode material 2, anode material 5) comprises 2-30 wt. % conductive carbon, 0-30 wt. % conductive additive, 1-20% wt. bismuth compound, 0-10 wt. % binder and birnessite or EMD. In one embodiment, the electrode material (e.g., cathode material 2, anode material 5) consists essentially of 2-30 wt. % conductive carbon, 0-30 wt. % conductive additive, 1-70 wt. % copper compound, 1-20 wt. % bismuth compound, 0-10 wt. % binder, and the balance is birnessite or EMD. In another embodiment, the electrode material (e.g., cathode material 2, anode material 5) consists essentially of 2-30 wt. % conductive carbon, 0-30 wt. % conductive additive, 1-20 wt. % bismuth compound, 0-10 wt. % binder, and the balance is birnessite or EMD.

The resulting electrode (e.g., cathode 12, anode 13) may have a porosity in the range of 20%-85% as determined by mercury infiltration porosimetry. The porosity can be measured according to ASTM D4284-12 “Standard Test Method for Determining Pore Volume Distribution of Catalysts and Catalyst Carriers by Mercury Intrusion Porosimetry” using the version as of the date of the filing of this application.

The electrode material (e.g., cathode material 2, anode material 5) can be formed on an electrode current collector (e.g., cathode current collector 1, anode current collector 4) formed from a conductive material that serves as an electrical connection between the electrode material (e.g., cathode material 2, anode material 5) and an external electrical connection or connections. As noted herein, the current collector may be metallic in some aspects. Since the current collector is not an electroactive material, the battery can be referred to as a metal-free battery even when the current collector comprises a metal. In some embodiments, the electrode current collector (e.g., cathode current collector 1, anode current collector 4) can be, for example, carbon, lead, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, bismuth, half nickel and half copper, or any combination thereof. In some embodiments, the electrode current collector (e.g., cathode current collector 1, anode current collector 4) can comprise a carbon felt, carbon foam, a conductive polymer mesh, or any combination thereof. The electrode current collector (e.g., cathode current collector 1, anode current collector 4) may be formed into a mesh (e.g., an expanded mesh, woven mesh, etc.), perforated metal, foam, foil, felt, fibrous architecture, porous block architecture, perforated foil, wire screen, a wrapped assembly, or any combination thereof. In some embodiments, the electrode current collector (e.g., cathode current collector 1, anode current collector 4) can be formed into or form a part of a pocket assembly, where the pocket can hold the electrode material (e.g., cathode material 2, anode material 5) within the electrode current collector (e.g., cathode current collector 1, anode current collector 4, respectively). A tab can be coupled to the current collector to provide an electrical connection between an external source and the current collector. The tab can be a portion of the electrode current collector (e.g., cathode current collector 1, anode current collector 4) extending outside of the electrode material (e.g., cathode material 2, anode material 5, respectively) as shown at the top of the electrodes (e.g., cathodes 12, anodes 13) in FIG. 1B.

The electrode material (e.g., cathode material 2, anode material 5) can be pressed onto the electrode current collector (e.g., cathode current collector 1, anode current collector 4) to form the electrode (e.g., cathode 12, anode 13, respectively). For example, the electrode material (e.g., cathode material 2, anode material 5) can be adhered to the electrode current collector (e.g., cathode current collector 1, anode current collector 4, respectively) by pressing at, for example, a pressure between 1,000 psi and 20,000 psi (between 6.9×10⁶ and 1.4×10⁸ Pascals). The electrode material (e.g., cathode material 2, anode material 5) may be adhered to the electrode current collector (e.g., cathode current collector 1, anode current collector 4, respectively) as a paste. The resulting electrode (e.g., cathode 12, anode 13) can have a thickness of between about 0.1 mm to about 5 mm.

In some embodiments, the cathode material and the anode material with their corresponding electroactive materials can also be formed from dissolved salts in the corresponding electrolytes (e.g., catholyte and anolyte, respectively). The process of forming the cathode material and the anode material from dissolved salts in the corresponding electrolytes would involve a charging step or a formation step, where the dissolved salts containing the active ions are plated onto the current collector by electrons flowing from an outside circuit. For example, manganese salts like manganese sulfate, manganese triflate, etc. in electrolytes with high proton activity will electroplate MnO₂ during the charging or formation step.

As shown in FIG. 1B, the battery 10 may not comprise a separator. The ability to form the battery 10 without a separator may allow for the overall cost of the battery to be reduced while having the same or similar performance to a battery with a separator. The use of a polymer gelled electrolyte (PGE) for the catholyte and the anolyte can serve the function of the separator by forming a physical barrier between the anode 13 and the cathode 12 to prevent short circuiting.

In some embodiments, a separator 9 (e.g., as shown in FIGS. 1A and 1C) and/or buffer layer can be disposed between the anode 13 and the cathode 12 when the electrodes are constructed into the battery. While shown as being disposed between the anode 13 and the cathode 12, the separator 9 can be used to wrap one or more of the anode 13 and/or the cathode 12, or alternatively one or more anodes 13 and/or cathodes 12 when multiple anodes 13 and cathodes 12 are present.

The separator 9 may comprise one or more layers. For example, when the separator is used, between 1 to 5 layers of the separator can be applied between adjacent electrodes. The separator can be formed from a suitable material such as nylon, polyester, polyethylene, polypropylene, poly(tetrafluoroethylene) (PTFE), poly(vinyl chloride) (PVC), polyvinyl alcohol, cellulose, or any combination thereof. Suitable layers and separator forms can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water of the material used in the separator is less than 30°. In yet another embodiment, the contact angle with water of the material used in the separator is less than 20°. The polyolefin may be modified by, for example, the addition of TRITON X100™ or oxygen plasma treatment. In some embodiments, the separator 9 can comprise a CELGARD® brand microporous separator. In an embodiment, the separator 9 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, a water electrolysis membrane, a composite of polyvinyl alcohol and graphene oxide, polyvinyl alcohol, crosslinked polyvinyl alcohol, or a combination thereof.

While the separator 9 can comprise a variety of materials, the use of a PGE for the electrolyte can allow for a relatively inexpensive separator 9 to be used when one or more separators are present. For example, the separator 9 can comprise CELLOPHANE®, polyvinyl alcohol, CELGARD®, a composite of polyvinyl alcohol and graphene oxide, crosslinked polyvinyl alcohol, PELLON®, and/or a composite of carbon-polyvinyl alcohol. Use of the separator 9 may help in improving the cycle life of the battery 20, but is not necessary in all embodiments.

When a buffer layer is used, the buffer layer can be used alone or in combination with a separator 9. The buffer layer can comprise a gelled solution that can comprise the same electrolyte formulation as the anolyte and/or the catholyte. For example, the buffer layer can be a PGE as described herein. One or more additives can also be present in the buffer layer such as calcium hydroxide, layered double hydroxides like hydrotalcites, quintinite, fougerite, magnesium hydroxide, or combinations thereof. For example, when the anolyte and catholyte have substantially the same formulation, only with different proton and hydroxyl anion compositions and/or viscosities, the buffer layer can have a concentration of the electrolyte that is the same as the anolyte or catholyte, or have a concentration that is between that of the anolyte and the catholyte. The buffer layer can have a viscosity greater than that of either the anolyte or catholyte to help prevent mixing between the anolyte and catholyte as well as limiting the migration of ions between the anolyte and catholyte.

As shown in FIGS. 1A-1D, a catholyte 3 can be in contact with the cathode 12, and an anolyte 6 can be in contact with the anode 13. As described in more detail herein, one or both of the catholyte 3 and/or the anolyte 6 can be polymerized or gelled to form separate gelled electrolytes to prevent mixing between the two electrolyte solutions. The catholyte 3 can be disposed in the housing 10 in contact with the cathode material 2. In some embodiments, the anolyte 6 can be polymerized or gelled, and the catholyte 3 can be a liquid. In other embodiments, the catholyte 3 can be polymerized or gelled, and the anolyte 6 can be a liquid. The polymerization of the anolyte 6 can prevent mixing between the catholyte 3 and the anolyte 6 even when the catholyte 3 is a liquid. Similarly, the polymerization of the catholyte 3 can prevent mixing between the catholyte 3 and the anolyte 6 even when the anolyte 6 is a liquid. In some embodiments, both the catholyte 3 and the anolyte 6 are gelled.

As disclosed herein, the electrolytes for the cathode and anode side should be separated. Acids are usually preferred for the cathode electrolyte (e.g., catholyte 3) and bases are usually preferred for the anode electrolyte (e.g., anolyte 6). However, the electrolytes can easily interchange between the two electrodes if desired. Nonlimiting examples of acids suitable for use in the electrolytes (e.g., catholyte 3, anolyte 6) disclosed herein include hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, or any combination thereof. Triflic acids are superacids with high proton activity and use of these acids can help boost potential significantly. Nonlimiting examples of bases suitable for use in the electrolytes (e.g., catholyte 3, anolyte 6) disclosed herein include ammonia, methylamine, glycine, lithium hydroxide, sodium hydroxide, potassium hydroxide, caesium hydroxide, rubidium hydroxide, calcium hydroxide, strontium hydroxide, barium hydroxide, or any combination thereof.

The acidic electrolyte (e.g., catholyte 3, anolyte 6) has a relatively high proton activity, which dictates the potential of the battery. The higher the activity of the protons in the electrolyte, the higher the potential of the battery. An acid dissociation constant (Kₐ) is a relatively good indicator for judging proton activity. Nonlimiting examples of acidic electrolytes or ions having low to very large Kₐ's suitable for use in the electrolyte (e.g., catholyte 3, anolyte 6) include hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, or any combination thereof. In some embodiments, the catholyte 3 comprises an acidic electrolyte.

The electrolyte (e.g., catholyte 3, anolyte 6) can be an acidic solution, wherein the pH of the electrolyte can be less than about 4, alternatively less than about 3, alternatively less than about 2, alternatively less than about 1, alternatively between −1.2 and 4, alternatively between −1.2 and 3, alternatively between −1.2 and 2, or alternatively between −1.2 and 1. The electrolyte (e.g., catholyte 3, anolyte 6) can be used in conditions having temperatures ranging between 0 and 200° C. In some embodiments, the electrolyte (e.g., catholyte 3, anolyte 6) can comprise an acid such as a mineral acid (e.g., hydrochloric acid, nitric acid, sulfuric acid, etc.). For acid electrolyte compositions, the acid concentration (e.g., concentration of the acidic electrolyte) can be between about 0.0001 M and about 16 M, alternatively from about 0.001 M to about 16 M, alternatively from about 0.01 M to about 16 M, alternatively from about 0.1 M to about 16 M, or alternatively from about 1 M to about 16 M.

In some embodiments, the hydrogen activity of the acidic electrolyte (e.g., catholyte 3, anolyte 6) can be altered by using acids of different strengths. Kₐ is a relatively good indicator for judging acid strengths. The following electrolytes or ions having low to very large Kₐ's can be used in the electrolyte solution: hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, or any combination thereof. While these examples of acidic electrolytes can help alter hydrogen (or proton) activity, it should be apparent to anyone skilled in chemistry or electrochemistry that any combination of acidic electrolytes and other electrolytes can be used to alter proton activity.

The alkaline electrolyte (e.g., catholyte 3, anolyte 6) has a relatively high hydroxyl activity, which dictates the potential of the battery. The higher the activity of the hydroxyl in the electrolyte, the higher the potential of the battery. Nonlimiting examples of alkaline electrolytes or ions having relatively high hydroxyl activity suitable for use in the electrolyte (e.g., catholyte 3, anolyte 6) include ammonia, methylamine, glycine, lithium hydroxide, sodium hydroxide, potassium hydroxide, caesium hydroxide, rubidium hydroxide, calcium hydroxide, strontium hydroxide, barium hydroxide, or any combination thereof. In some embodiments, the anolyte 6 comprises a basic electrolyte (e.g., an alkaline electrolyte).

In some embodiments, the anolyte can be an alkaline electrolyte (e.g., a relatively highly alkaline electrolyte), while the catholyte can be an acidic solution (e.g., a relatively highly acidic solution).

The alkaline electrolyte can be a hydroxide such as potassium hydroxide, sodium hydroxide, lithium hydroxide, ammonium hydroxide, cesium hydroxide, or any combination thereof. The resulting electrolyte (e.g., catholyte 3, anolyte 6) can have a pH of equal to or greater than 10, alternatively equal to or greater than 11, or alternatively equal to or greater than 12, or alternatively equal to or greater than 13. In some embodiments, the pH of the alkaline electrolyte (e.g., catholyte 3, anolyte 6) can be greater than or equal to about 10 and less than or equal to about 15.13, alternatively greater than or equal to about 11 and less than or equal to about 15.13, alternatively greater than or equal to about 12 and less than or equal to about 15.13, or alternatively greater than or equal to about 13 and less than or equal to about 15.13. As described herein, the electrolyte (e.g., catholyte 3, anolyte 6) can be polymerized or gelled. The resulting electrolyte can be in a semi-solid state that resists flowing within the battery. This can serve to limit or prevent any mixing between the anolyte and the catholyte. The electrolyte (e.g., catholyte 3, anolyte 6) can be polymerized using any suitable techniques, including any of those described herein. In some embodiments, the alkaline electrolyte can be present in the anolyte 6 and/or catholyte 3 in an amount of 1-70 wt. %, alternatively 1-25 wt. %, alternatively 25-70 wt. %, alternatively 20-60 wt. %, alternatively 20-55 wt. %, alternatively 30-55 wt. %, alternatively 1-60 wt. %, alternatively 1-55 wt. %, alternatively 5-60 wt. %, alternatively 10-60 wt. %, or alternatively 20-60 wt. %, based on the total weight of the anolyte 6 and/or catholyte 3, respectively. Usually a higher concentration of alkaline electrolyte is used to increase the solubility of metal ions in the gelled state in the electrolyte. For example, the higher concentration of alkaline electrolyte can be between 25-70 wt. % of the anolyte 6 and/or catholyte 3.

In some embodiments, the hydroxyl activity of the electrolyte (e.g., catholyte 3, anolyte 6) can be altered by using bases of different strengths, where the following from low to high strength can be used: ammonia, methylamine, glycine, lithium hydroxide, sodium hydroxide, potassium hydroxide, caesium hydroxide, rubidium hydroxide, calcium hydroxide, strontium hydroxide, barium hydroxide, or any combination thereof. While these examples of alkaline electrolytes can help alter hydroxyl activity, it should be apparent to anyone skilled in chemistry or electrochemistry that any combination of alkaline electrolytes and other electrolytes can be used to alter hydroxyl activity.

Electrolyte additives can help in boosting the performance of the cathode and anode materials. Nonlimiting examples of electrolyte additives suitable for use in the acidic electrolyte (e.g., acidic cathode electrolyte, catholyte 3) as disclosed herein include manganese sulfate, nickel sulfate, potassium permanganate, manganese chloride, manganese acetate, manganese triflate, bismuth chloride, bismuth nitrate, manganese nitrate, nickel sulfate, nickel nitrate, zinc sulfate, zinc chloride, zinc acetate, zinc triflate, indium chloride, copper sulfate, copper chloride, lead sulfate, sodium persulfate, potassium persulfate, ammonium persulfate, ammonium chloride, vanillin, potassium chloride, sodium chloride, lithium nitrate, lithium chloride, lithium carbonate, lithium acetate, lithium triflate, aluminum trifluoromethanesulfonate, aluminum chloride, aluminum nitrate, potassium sulfate, sodium sulfate, ammonium sulfate, potassium bicarbonate, sodium bicarbonate, or any combination thereof. The concentration of the electrolyte additives in the electrolyte can be between 0 M and 5 M. Nonlimiting examples of electrolyte additives suitable for use in the basic electrolyte (e.g., alkaline anode electrolyte, anolyte 6) as disclosed herein include vanillin, indium hydroxide, zinc acetate, zinc oxide, manganese acetate, cetyltrimethylammonium bromide, sodium dodecyl sulfate, sodium dodecylbenzene sulfonate, polyethylene glycol, ethanol, methanol, zinc gluconate, manganese gluconate, manganese acetate, glucose, or any combination thereof.

Acidic electrolyte (e.g., catholyte 3) additives can help with boosting the performance of the electrode material (e.g., cathode material). Nonlimiting examples of acidic electrolyte additives (e.g., catholyte additives) suitable for use in this disclosure include manganese sulfate, nickel sulfate, potassium permanganate, manganese chloride, manganese acetate, manganese triflate, bismuth chloride, bismuth nitrate, manganese nitrate, nickel sulfate, nickel nitrate, zinc sulfate, zinc chloride, zinc acetate, zinc triflate, indium chloride, copper sulfate, copper chloride, lead sulfate, sodium persulfate, potassium persulfate, ammonium persulfate, ammonium chloride, vanillin, potassium chloride, sodium chloride, lithium nitrate, lithium chloride, lithium carbonate, lithium acetate, lithium triflate, aluminum trifluoromethanesulfonate, aluminum chloride, aluminum nitrate, potassium sulfate, sodium sulfate, ammonium sulfate, or any combination thereof. The concentration of catholyte additives can be between 0 and 5 M.

In some embodiments, the acidic electrolyte solution (e.g., catholyte solution) can comprise a solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, ammonium chloride, ammonium sulfate, ammonium hydroxide, zinc sulfate, zinc triflate, zinc acetate, zinc nitrate, bismuth chloride, bismuth nitrate, nitric acid, sulfuric acid, hydrochloric acid, sodium sulfate, potassium sulfate, cobalt sulfate, lead sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium sulfate, lithium bromate, polyvinyl alchohol, carboxymethyl cellulose, xanthan gum, carrageenan, acrylamide, potassium persulfate, sodium persulfate, ammonium persulfate, N,N′-methylenebisacrylamide, or any combination thereof. For example, the catholyte solution can comprise manganese sulfate mixed with sulfuric acid or potassium permanganate mixed with sulfuric acid. Other dopants to this solution can be zinc sulfate, lead sulfate, titanium disulfide, titanium sulfate hydrate, silver sulfate, cobalt sulfate, and nickel sulfate. In some embodiments, the catholyte solution can comprise manganese sulfate, ammonium chloride, ammonium sulfate, manganese acetate, potassium permanganate, and/or a salt of permanganate, where the additives can have a concentration between 0 and 10 M. Depending on the type of manganese salts used voltage of the battery system can be different. For example, in manganese sulfate electrolyte the voltage of the SS-HiVAB is around 2.45-2.5V, while in potassium permanganate electrolyte the voltage of the SS-HiVAB is around 2.8-2.9V.

In some embodiments, the acidic electrolyte (e.g., catholyte 3) can comprise a permanganate. Permanganates have a high positive potential. This can allow the overall cell potential to be increased within the battery 10. When present, the permanganate can be present in a molar ratio of an acid (e.g., a mineral acid such a hydrochloric acid, sulfuric acid, etc.) to permanganate of between about 5:1 to about 1:5, or about 1:1 to about 1:6, or between about 1:2 to about 1:4, or about 1:3, though the exact amount can vary based on the expected operation conditions of the battery 10. The concentration of the permanganate (e.g., potassium permanganate or a salt of permanganate, etc.) can be greater than 0 and less than or equal to 5 M. In some embodiments, the acidic electrolyte solution (e.g., catholyte solution) comprises sulfuric acid, hydrochloric acid or nitric acid at a concentration greater than 0.0001 M and less than or equal to 16 M. The use of a permanganate can be advantageous for creating a high voltage battery. When the catholyte comprises a permanganate, suitable permanganates can include, but are not limited to, potassium permanganate, sodium permanganate, lithium permanganate, calcium permanganate, and combinations thereof.

In addition to a hydroxide, the alkaline electrolyte (e.g., anolyte 6) can comprise additional components. In some embodiments, the alkaline electrolyte can have zinc oxide, potassium carbonate, potassium iodide and potassium fluoride as additives. When zinc compounds are present in the anolyte, the anolyte can comprise zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, sodium hydroxide, potassium hydroxide, lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, acrylic acid, N,N′-methylenebisacrylamide, potassium persulfate, ammonium persulfate, sodium persulfate, or a combination thereof.

In some embodiments, the alkaline electrolyte (e.g., anolyte 6) can comprise electrolyte additives (e.g., anolyte additives), such as vanillin, indium hydroxide, zinc acetate, zinc oxide, cetyltrimethylammonium bromide, sodium dodecyl sulfate, sodium dodecylbenzene sulfonate, polyethylene glycol, ethanol, methanol, zinc gluconate, manganese gluconate, manganese acetate, glucose, or any combination thereof.

In some embodiments, an organic solvent containing a suitable salt can be used as an electrolyte. Examples of suitable organic solvents include, but are not limited to, cyclic carbonates, linear carbonates, dialkyl carbonates, aliphatic carboxylate esters, γ-lactones, linear ethers, cyclic ethers, aprotic organic solvents, fluorinated carboxylate esters, and combinations thereof. Any suitable additives including salts as described herein can be used with the organic solvents to form an organic electrolyte for the anolyte and/or catholyte.

In some embodiments, an ionic liquid can be used to form a gelled electrolyte (e.g., a gelled anolyte, a gelled catholyte, etc.). The ionic liquids can comprise 1-ethyl-3-methylimidazolium chloride (EMImCl), 1-allyl-3-methylimidazolium bromide, 1-allyl-3-methylimidazolium chloride, 1-butyl-2, 3-dimethylimidazolium chloride, 1-ethyl-3-methylimidazolium acetate, 1-ethyl-3-methylimidazolium bromide, 1-ethyl-3-methylimidazolium tetrachloroaluminate, lithium hexafluorophosphate (LiPF₆), lithium perchlorate, lithium bis(trifluoromethanesulfonyl)imide, lithium bis(oxalato)borate, and combinations thereof. Other ionic liquids are known and can also be used. In some embodiments, EMImCl can be used as the ionic liquid and can be purified before mixing with an aluminum salt to form an aluminum-ion conducting electrolytes. The aluminum salt can be aluminum chloride, aluminum acetate, aluminum nitrate, aluminum bromide, and others. The mixture of EMImCl with aluminum chloride can be made by slowly adding a precise amount of aluminum chloride in an inert atmosphere. The mixing ratio of aluminum chloride with EMImCl can be between 5:1 to 1:1, or about 1.5:1.

In some embodiments, a water in salt electrolyte can be gelled and used as the catholyte and/or anolyte. A water in salt electrolyte can include an electrolyte in which the salt concentration is above the saturation point. The activity of water in an aqueous electrolyte can be further reduced by increasing the salt concentration above the saturation point in order to form a water in salt electrolyte. The ionic conductivity of such electrolytes can be higher than those in a regular aqueous electrolyte. A water in salt electrolyte can comprise water along with a suitable salt above its saturation point, including any of the salts and additives described herein with regard to the aqueous anolyte and/or catholyte.

The anolyte and the catholyte need to be kept separated or decoupled so that neutralization does not take place. Such separation can be achieved by using a separator, through gelation or polymerization of the electrolytes, and any combination thereof.

One or both of the anolyte and the catholyte can be gelled in the battery. The polymerization process can be performed with any electrolyte, including any of those described herein (e.g., organic, aqueous, ionic liquid, water in salt, etc.). A number of polymerization techniques can be used to form the gelled/solid electrolyte—for example, step-growth, chain-growth, emulsion polymerization, solution polymerization, suspension polymerization, precipitation polymerization, photopolymerization and others. Once the gelled/solid electrolytes are formed through the polymerization step, they can be combined in a single battery housing as described herein. The battery can use separators or be membrane-less or separator-less.

As described herein, the electrolyte can be polymerized or gelled to form a polymer gel electrolyte (PGE) for the catholyte and/or the anolyte. The resulting PGE can be in a semi-solid state that resists flowing within the battery. For example, the PGE can comprise an inert hydrophilic polymer matrix impregnated with aqueous electrolyte. The electrolyte can be polymerized using any suitable techniques. In an embodiment, a method of forming a PGE can begin with selecting a monomer material for the PGE. The monomer can be polar vinyl monomer selected from the group consisting of acrylic acid, vinyl acetate, acrylate esters, vinyl isocyanate, acrylonitrile, or any combinations thereof. The aqueous electrolyte component can then be selected, and can include any of the components described above with respect to the electrolyte. An initiator can be added to start the polymerization process. In some embodiments, a cross-linker can be used in the electrolyte composition to further cross-link the polymer matrix in order to form the PGE. The monomer in the composition (e.g., a polar vinyl monomer) can be present in an amount of between about 5% to about 50% by weight, the initiator can be present in an amount of between about 0.001 wt. % to about 0.1 wt. %, and the cross-linker can be present in an amount of between 0 to 5 wt. %.

In some embodiments, the PGE can be formed in-situ, which refers to the introduction of the electrolyte as a liquid into the housing followed by subsequent polymerization to form the PGE within the housing. This method can allow the electrolyte composition to soak into the void spaces, the anode, and/or the cathode prior to fully polymerizing to form the PGE. In some embodiments, a vacuum (e.g., a pressure less than atmospheric pressure) can be created within the housing 7 upon introduction of the electrolyte into the corresponding compartment. The vacuum can serve to remove air and allow the electrolyte to penetrate the anode 13, the cathode 12, and/or the various void spaces within the battery 10. In some embodiments, the vacuum can be between about 10 and 29.9 inches of mercury or between about 20 and about 29.9 inches of mercury vacuum. The use of the vacuum can help to avoid the presence of air pockets within the battery 10 prior to the full polymerization of the electrolyte. In some embodiments, the electrodes can be soaked in the electrolyte solution for between 1-120 minutes at a temperature of between 0° C. to 30° C. prior to full polymerization of the electrolyte to allow the electrolyte to impregnate the electrodes. Once the electrolyte is polymerized, the battery can be allowed to rest prior to use. In some embodiments, the battery can be allowed to rest for between 5 minutes and 24 hours.

In order to help impregnate the electrodes with the electrolyte, the electrodes can be pre-soaked with the selected electrolyte solution prior to polymerizing the electrolyte. This can be performed by soaking the electrodes in the electrolyte (e.g., in a catholyte or anolyte separately) outside of the battery or housing, and then placing the pre-soaked electrodes into the housing to construct the battery. In some embodiments, an electrolyte that does not contain a polymer or gelling agent can be introduced into the battery to soak the electrodes in-situ. This can include the use of a vacuum to assist in impregnating the electrodes. The electrodes can be soaked for between about 1 minute and 24 hours. In some embodiments, the soaking can be carried out over a plurality of cycles in which the battery is filled with the electrolyte and allowed to soak, drained, refilled and allowed to soak, followed by draining a desired number of times. Once the electrodes are soaked and impregnated with the electrolyte, the electrolyte containing the polymer and polymerization agents (e.g., an initiator, cross-linking agent, etc.) can be introduced into the housing and allowed to polymerize to form the final battery.

The composition of the electrolyte, the monomer material, the initiator, and the conditions of the formation (e.g., temperature, etc.) can be selected to provide a desired polymerization time to allow the electrolyte composition to properly soak the components of the battery to absorb and penetrate into the electrodes. The temperature can be controlled to control the polymerization process, where relatively colder temperatures can inhibit or slow the polymerization, and relatively warmer temperatures can decrease the polymerization time or accelerate the polymerization process. In addition, an increase in an alkaline electrolyte component (e.g., a hydroxide) can decrease the polymerization time, and an increase in the initiator concentration will decrease the polymerization time. Suitable polymerization times can be between 1 minute and 24 hours, based on the composition of the electrolyte solution and the temperature of the reaction.

In some embodiments, the anolyte and/or the catholyte can be formed via a gelation process, such as a free radical polymerization technique, wherein acrylic acid can be used as the monomer, for example. Acrylic acid can be mixed with either the anolyte or catholyte until it is substantially dissolved. A cross-linker like N,N′-methylenebisacrylamide (MBA) can be used to increase the strength of the polymer. For the acidic electrolyte (e.g., anolyte), the process of mixing the acrylic acid with the MBA can be usually done at relatively cold temperatures because of the heat generated in the reaction. However, for the alkaline electrolyte (e.g., catholyte), the mixture of acrylic acid and MBA can be heated between 50-200° C. The polymerization can be initiated through the addition of an initiator like a persulfate salt, such as potassium persulfate, sodium persulfate, ammonium persulfate, or any combination thereof. The electrolyte additives (e.g., anolyte additive, catholyte additive) disclosed herein can be included during the gelation process. Ionomers can also be added during the gelation process. Nonlimiting examples of ionomers that can be added to the electrolyte during the gelation process include Nafion solutions which are made from perfluorosulfonic acid (PFSA)/polytetrafluoroethylene (PTFE) copolymer in the acid form or anion exchange ionomers with polyaromatic polymer.

As an example of a polymerization process, a mixture of acrylic acid, N,N′-methylenebisacrylamide, and alkaline solution can be created at a temperature of around 0° C. Any additives can then be added to the solution (e.g., gassing inhibitors, additional additives as described herein, etc.). For example, electrolyte additives, when used in the electrolyte, can be dissolved in the alkaline solution after mixing the precursor components, where the electrolyte additive can beneficial during the electrochemical cycling of the electrode. To polymerize the resulting mixture an initiator such as potassium persulfate can be added to initiate the polymerization process and form a solid or semi-solid polymerized electrolyte (e.g., a PGE). The resulting polymerized electrolyte can be stable over time once the polymerization process has occurred.

As an example, a PGE described herein can be made through a free radical polymerization process. In an embodiment, acrylic acid (AA) can be used as a monomer with N,N′-methylenebisacrylamide (MBA) as the cross-linker and potassium persulfate (K₂S₂O₈) as the initiator. When preparing the anolyte, an alkaline electrolyte such as KOH can be added to this process, which can be embedded in the anolyte gel/polymer framework. The addition of alkaline electrolyte to AA results in neutralization, which reduces the concentration of the alkaline electrolyte in the polymeric gel. Differing alkaline electrolyte concentrations can alter the gelation time. Higher alkaline electrolyte concentrations usually result in faster gelation, while lower alkaline electrolyte concentrations take longer times. Further, initiator concentration can affect the gelation process. Furthermore, the viscosity of the gel can be tuned by altering the monomer and MBA concentration, which can also affect ionic conductivity. Similarly, when preparing the catholyte, an acidic electrolyte such as sulfuric acid can be added to this process, which can be embedded in the catholyte gel/polymer framework.

In some embodiments, an ionomer gelation layer can also be made, wherein the ionomer gelation layer can separate the catholyte and anolyte solutions or gels. The gelation process for forming the ionomer gelation layer is substantially similar to the gelation process of forming the anolyte and/or catholyte gels as described herein, wherein the ionomers are added to the electrolyte during the gelation process. The ionomer gels (e.g., ionomer gelation layers) can also contain additives such as potassium sulfate, sodium sulfate, ammonium sulfate, potassium carbonate, sodium carbonate, potassium bicarbonate, sodium bicarbonate, or any combination thereof. Ionomer resins can also be used in the gelation process to produce an ionomer gelation layer.

The polymerization process can occur prior to the construction of the battery 10 or after the cell is constructed. In some embodiments, the electrolyte can be polymerized and placed into a tray to form a sheet. Once polymerized, the sheet can be cut into a suitable size and shape and one or more layers can be used to form the electrolyte in contact with the electrode. When a pre-formed PGE is used, additional liquid electrolyte can be introduced into the battery and/or the electrodes can be pre-soaked with the electrolyte prior to constructing the battery.

In some embodiments, the PGE can be formed using an aqueous electrolyte, organic electrolyte, ionic liquid, water in salt electrolyte, and the like. In some embodiments, an aqueous electrolyte can be used for the catholyte and/or anolyte and gelled to form an aqueous hydrogel as the PGE. In some embodiments, aqueous hydrogels can be made through a free radical polymerization process. For example, when preparing the anolyte, acrylic acid (AA) can be selected as the monomer with N,N′-methylenebisacrylamide (MBA) as the cross-linker and potassium persulfate as the initiator. In aqueous alkaline anolytes, a suitable hydroxide (e.g., potassium hydroxide (KOH), sodium hydroxide, lithium hydroxide, etc.) can be used to form the electrolyte. The hydroxide can be encapsulated in a hydrogel network by neutralizing the hydroxide with the AA. To create a hydrogel, the monomer can be combined with any cross-linker until the cross-linker is dissolved. Separately, an amount of the hydroxide can be cooled to slow the reaction. In some embodiments in which the anolyte is an aqueous electrolyte, the hydroxide can be cooled to a temperature below about 10° C., below about 5° C., or below about 0° C. The mixed solution of the monomer and any cross-linker can then be added drop-wise to the chilled solution of the hydroxide as the neutralization reaction releases heat. To gel the resulting mixture of the hydroxide, monomer, and cross-linker, an initiator such as potassium persulfate can be added. The mixture can then be allowed to form a PGE. The amounts and concentrations of the ingredients can be varied to obtain varying mechanical strengths of the hydrogels. Similarly, when preparing the catholyte, an acidic electrolyte such as sulfuric acid can be encapsulated in a hydrogel network.

Electrolytes comprising ionic liquids can also be used to form PGEs, including any of the ionic liquid described herein. To form a PGE using an ionic liquid, a solution of any additives, which can be in a suitable solvent, can be prepared and a monomer can be added. The monomer can be any suitable monomer. For example, acrylamide can be used as a polymerization agent for ionic liquids. To this solution, the ionic liquid along with the additive solution can be mixed along with an initiator. Any suitable initiator for use with the polymerization agent can be used. For example, azobisisobutyronitrile can be used with acrylamide. The initiator can be added in a suitable amount such as about 1 wt. % of the polymerization agent. This final solution can then be heated to form a polymerized gel.

Organic electrolytes comprising a salt dissolved in an organic solvent can also be gelled to form an anolyte and/or catholyte. As an example, lithium-ion conducting electrolytes can be gelled using a number of polymerization techniques such as ring-opening polymerization, photo-initiated radical polymerization, UV-initiated radical polymerization, thermal-initiated polymerization, in-situ polymerization, UV-irradiation, electrospinning, and others. The lithium electrolyte can comprise lithium hexafluorophosphate (LiPF₆), lithium perchlorate, lithium bis(trifluoromethanesulfonyl)imide, lithium bis(oxalato)borate, and combinations thereof in an organic solvent such as ethylene carbonate, dimethyl carbonate, propylene carbonate, diethyl carbonate, ethyl methyl carbonate, and combinations thereof. An exemplary mixture can include 1 M LiPF₆ mixed in a solvent mixture of ethylene carbonate and dimethyl carbonate. Other solvents also exist that can be used as a mixture to reduce the flammability of the organic electrolyte.

The organic electrolyte can be gelled by mixing the selected salts with the organic solvent. A gelling agent can then be added along with an initiator. The gelling agent can be added in an amount between about 0.1 to about 5 wt. % of the mixture, and the initiator can be added in an amount of between about 0.01 to about 1 wt. % of the mixture. In some embodiments, a suitable gelling agent for an organic electrolyte can comprise pentaerythritol tetraacrylate and the initiator can comprise azodiisobutyronitrile. The resulting mixture can be gelled (e.g., polymerized) by heating the mixture to about 50-90° C., or to about 70° C. and holding for 1-24 hours.

For an aqueous electrolyte which is acidic in nature, such as the catholyte, the polymerization can be carried out using a number of processes. In an embodiment, a method for making a solid state gelled aqueous acid electrolyte can comprise the addition of acrylamide to a solution comprising manganese sulfate, H₂SO₄, ammonium sulfate, potassium permanganate, and/or sulfuric acid. A gelling agent comprising acrylamide can be added to the solution and mixed at a temperature between about 70-90° C. for at least an hour until the solution is homogenous. After the solution is mixed well, then a cross-linker and initiator can be added to the solution and mixed between 2-48 hours until the solution gels.

In some embodiments, the separator comprises an ion-selective gel; wherein the ion-selective gel comprises an ionomer, a bipolar membrane, a cation-exchange membrane, an anion-exchange membrane, a cellophane grafted with ion-selective properties, a polyvinyl alcohol grafted with ion-selective properties, a ceramic separator, NaSiCON, LiSiCON, or any combination thereof.

While an anolyte PGE and a catholyte PGE can be used without a separator, separation of the catholytes and anolytes can also be done through ion-selective ceramic separators and/or polymeric membranes. Cellulose-based membranes like cellophane can also be used to separate the catholytes and anolytes. For example, ceramic separators like LiSiCON and/or NaSiCON can be used to separate the catholytes and anolytes. As another example, polymeric membranes having cation-exchange properties like Nafion and/or anion-exchange membranes can be used to separate the catholytes and anolytes. Polyvinyl alcohol (PVA) and/or cross-linked polyvinyl alcohol (C-PVA) can also be used as polymeric separators to separate the catholytes and anolytes. The cellulose-based membranes, PVA, and C-PVA can be grafted with ionomers that may impart cation and/or anion exchange properties. Bipolar membranes can also be used as separators between catholytes and anolytes.

Gels or polymeric membranes containing LiSiCON and NaSiCON can be made using the procedures described herein for the formation of PGEs and/or ionomer gelation layers, by using raw materials used in making ceramic separators.

The cathodes and anodes used in the high voltage metal-free battery as disclosed herein can advantageously access 5-100%, or alternatively 50-100% of the theoretical capacity at wide range of current densities and material loading.

The high voltage metal-free battery as disclosed herein does not have display dendrite or shorting issues because of the absence of metal electrodes.

The final cell or battery design could have a cathode with an acidic PGE catholyte and an anode with an alkaline PGE anolyte with a separator or buffering layer that prevents the intermixing of the two PGE's. A battery with dual electrolytes allows for high reversibility and improved or maximum utilization of the electrodes and thus, a higher energy density. The use of vastly different alkalinity and acidity in the anolyte and catholyte further allows for increasing the average discharge of the battery to greater than about 1.6 V.

In some embodiments, the high voltage metal-free battery as disclosed herein can be used for producing energy. For example, a method for producing energy may comprise (i) discharging the high voltage metal-free battery as disclosed herein to a discharge voltage to produce energy, wherein at least a portion of the anode electroactive material is oxidized during the discharging to form an oxidized anode material; and (ii) charging the high voltage metal-free battery to a charge voltage, wherein at least a portion of the oxidized anode material is reduced to the anode electroactive material during the charging. The discharge voltage can be greater than 1.6 V, alternatively equal to or greater than about 2 V, alternatively equal to or greater than about 3 V, alternatively equal to or greater than about 3.5 V, alternatively from greater than about 1.6 V to about 5 V, alternatively from about 2 V to about 5 V, alternatively from about 3 V to about 5 V, or alternatively from about 3.5 V to about 5 V.

### EXAMPLES

The subject matter having been generally described, the following examples are given as particular aspects of the disclosure and are included to demonstrate the practice and advantages thereof, as well as preferred aspects and features of the inventions. It should be appreciated by those of skill in the art that the techniques disclosed in the examples which follow represent techniques discovered by the inventors to function well in the practice of the inventions, and thus can be considered to constitute preferred modes for its practice. However, those of skill in the art should, in light of the present disclosure, appreciate that many changes can be made in the specific aspects which are disclosed and still obtain a like or similar result without departing from the scope of the inventions of the instant disclosure. It is understood that the examples are given by way of illustration and are not intended to limit the specification of the claims to follow in any manner.

### Example 1

A schematic drawing of the battery with prismatic geometry is shown in FIG. 1A. The battery can be of any geometric form factor and can be flexible as well. It can be scaled up to any size (physically and capacity (Ah)) depending on the application it is meant to serve. FIG. 1A displays a schematic drawing of the high voltage metal-free battery.

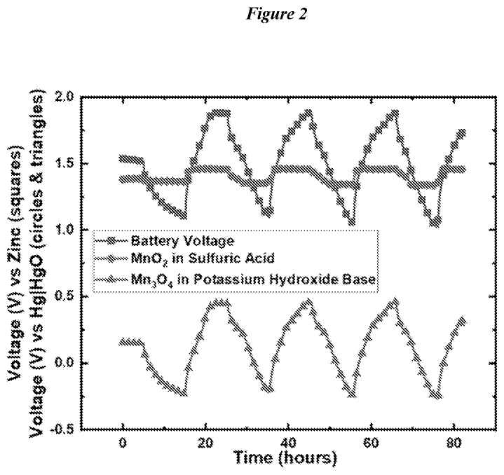

Manganese dioxide (MnO₂), more specifically electrolytic manganese dioxide (EMD), was chosen as the example cathode system. Traditional or conventional alkaline MnO₂|Zn batteries have an OCV of about 1.6 V. In the high voltage metal-free MnO₂|hausmannite (Mn₃O₄) aqueous battery, the OCV is dictated by the concentrations of catholyte and anolyte used. For the rechargeable battery, the catholyte used was 3 M sulfuric acid with 0.5 M manganese sulfate as the additive, while the anolyte used was 25 wt. % potassium hydroxide. The cathode composition was 80 wt. % MnO₂, 15 wt. % expanded graphite and 5 wt. % Teflon pasted on a titanium current collector, while the anode composition was similar with bismuth oxide as an additive pasted on a nickel current collector. Nafion 115 was used as the ion-selective membrane separator. The OCV of this battery was about 1.6 V. The cathode and anode were monitored against a reference electrode and its potentials are shown in FIG. 2 along with the battery voltage. FIG. 2 displays the performance of a rechargeable electrolytic manganese dioxide (MnO₂)|hausmannite (Mn₃O₄) battery with battery voltage against Mn₃O₄, cathode (MnO₂) against mercury|mercury oxide (Hg|HgO) and anode (Mn₃O₄) against Hg|HgO reference electrode; wherein the catholyte used was 3 M sulfuric acid and 0.5 M manganese sulfate, and wherein the anolyte used was 25 wt. % potassium hydroxide. MnO₂ was able to cycle to one electron (308 mAh/g) and two electrons (617 mAh/g) capacity. This battery was able to cycle at its rated capacity without any loss in voltage and capacity many times as shown in FIG. 2.

### Example 2

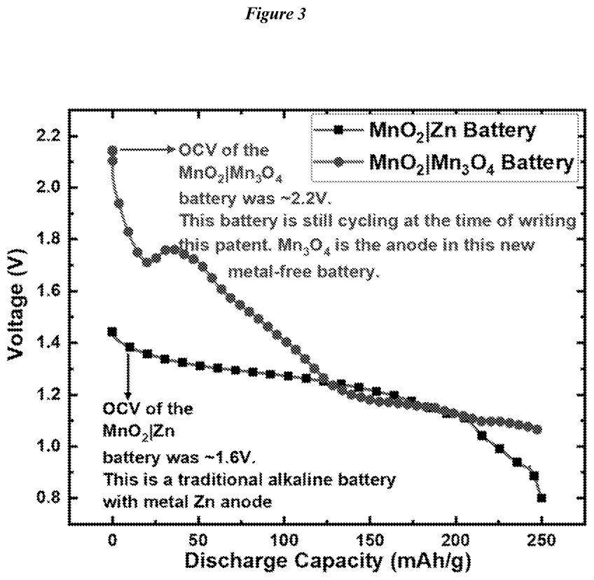

Another high voltage metal-free MnO₂|Mn₃O₄ aqueous battery was assembled with similar cathode and anode mix compositions as described in Example 1, unless otherwise indicated herein. A MnO₂|Mn₃O₄ with similar experimental details as described in Example 1 was assembled for primary discharge tests and to make comparisons with conventional or traditional alkaline MnO₂|Zn battery. The catholyte used was 16 M sulfuric acid, while the anolyte used was 45 wt. % potassium hydroxide. The OCV of this battery was about 2.2 V, which is 0.6 V higher than for the traditional alkaline battery. In terms of discharge performance, the new metal-free battery was able to deliver a higher energy when compared to the energy delivered by the traditional alkaline battery, as shown in FIG. 3. FIG. 3 displays discharge curve comparisons of the new metal-free electrolytic manganese dioxide (MnO₂)|hausmannite (Mn₃O₄) battery and a traditional electrolytic manganese dioxide (MnO₂)|zinc (Zn) battery; wherein the electrolytes used in the new metal-free MnO₂|Mn₃O₄ battery were 16 M sulfuric acid as the catholyte, and 45 wt. % potassium hydroxide as the anolyte. As shown in FIG. 3, the new MnO₂|Mn₃O₄ battery outperforms the traditional MnO₂|Zn battery in terms of energy and capacity. The electrolyte used in the traditional MnO₂|Zn battery was 25 wt. % potassium hydroxide (KOH).

### Example 3

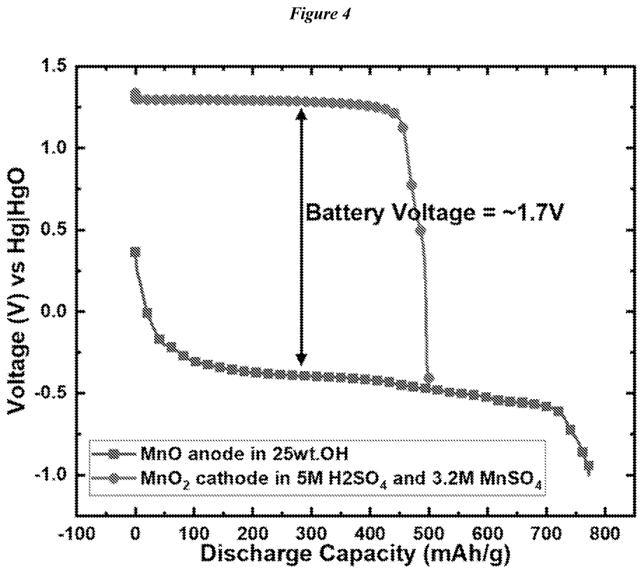

Another high voltage metal-free MnO₂|Mn₃O₄ aqueous battery was investigated for its properties. The cathode was similar to the cathode described in Examples 1 and 2. The anode in Example 3 was manganese oxide (MnO), which has a theoretical capacity of about 750 mAh/g. This anode (MnO) had similar compositions as described for the anode in Example 1, but with bismuth oxide as an electrode additive. This anode material (MnO based anode) was pasted onto a nickel mesh with copper as a backing. The discharge performance of this new battery chemistry MnO₂|MnO was tested with measuring the voltages of the respective cathodes and anodes individually, and the data are displayed in FIG. 4. FIG. 4 shows the discharge capacity of an electrolytic manganese dioxide (MnO₂)|manganese oxide (MnO) battery; wherein the catholyte used was 5 M sulfuric acid and 3.2 M manganese sulfate as the additive, and wherein the anolyte used was 25 wt. % potassium hydroxide. The average discharge voltage of this battery was about 1.7 V, which is higher than the average discharge voltage of any conventional or traditional alkaline battery. The MnO₂ cathode was tested to its theoretical 2^{nd} electron capacity, which it was able to achieve. In higher concentrations of acidic electrolyte, the cathode seems to go through a direct dissolution-precipitation reaction as seen by the flatness of the cathode curve. The MnO is known to go through a direct dissolution-precipitation reaction.

### Example 4

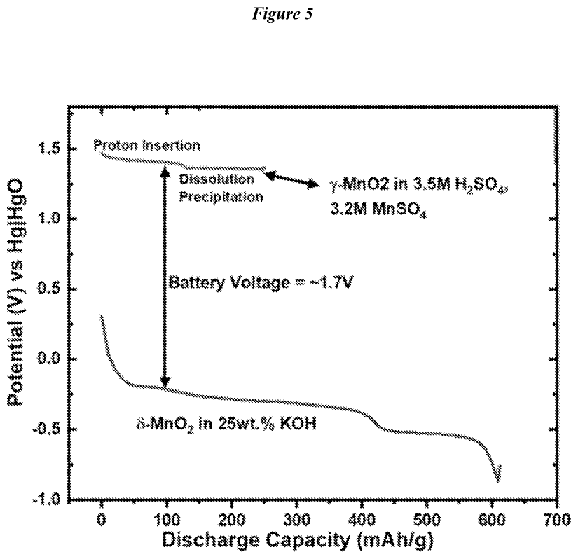

Another high voltage metal-free battery was investigated for its properties. The cathode used was γ-MnO₂. This cathode was made in-situ through conversion of electrolytic manganese dioxide. The cathode formulation was similar to the cathode described in Example 1. The anode in Example 4 was birnessite (δ-MnO₂). This new system (γ-MnO2|δ-MnO₂) would be the first demonstration ever in patent or academic literature of a complete single redox active Mn element based battery, where the cathode and anode are both MnO₂. The δ-MnO₂ can be synthesized ex-situ or in-situ. The δ-MnO₂ was made in-situ through a formation process starting with electrolytic manganese dioxide mixed with bismuth oxide and copper. After the formation, the cathode becomes copper intercalated bismuth-birnessite. The anode used in Example 4 had similar composition to the anode described in Example 1 with it being pasted onto a nickel mesh. The discharge performance of this new battery chemistry γ-MnO₂|δ-MnO₂ was tested with measuring the voltages of the respective cathodes and anodes individually. This is shown in FIG. 5. FIG. 5 displays the discharge capacity of a gamma-manganese dioxide (γ-MnO₂)|birnessite (δ-MnO₂) battery; wherein the catholyte used was 3.5 M sulfuric acid with 3.2 M manganese sulfate, and wherein the anolyte used was 25 wt. % potassium hydroxide. The average discharge voltage of this battery was about 1.7 V, which is higher than any conventional or traditional alkaline battery. The sigmoidal shaped curve indicating proton insertion and flat shaped curve indicating dissolution-precipitation of the γ-MnO₂ can be seen in FIG. 5. The cathode could theoretically go till 617 mAh/g, but for the purposes of showing a different mechanism the capacity was limited. Both the cathode and anode should deliver theoretical 617 mAh/g. This is the first such demonstration of this novel γ-MnO₂|δ-MnO₂ battery chemistry in patent or academic literature.

### Additional Disclosure

The following is provided as additional disclosure for combinations of features and aspects of the presently disclosed subject matter.

A first aspect, which is a high voltage metal-free battery comprising a cathode comprising a cathode electroactive material in the form of organic compounds, oxides, hydroxides and sulfides; an anode comprising an anode electroactive material in the form of organic compounds, oxides, hydroxides and sulfides; a catholyte solution with high proton activity in contact with the cathode, wherein the catholyte is not in contact with the anode; an anolyte solution with high hydroxyl activity in contact with the anode, wherein the anolyte is not in contact with the cathode; and a separator with ion-selective properties.

A second aspect, which is the battery of the first aspect, wherein the cathode electroactive material comprises manganese dioxide (MnO₂), manganese oxides (Mn₂O₃, Mn₃O₄, MnO), manganese hydroxides (MnOOH, Mn(OH)₂), silver oxides (AgO, Ag₂O), nickel oxide (NiO, Ni₂O₃), nickel hydroxides (NiOOH, Ni(OH)₂), cobalt oxide (Co₃O₄, CoO), cobalt hydroxides, lead oxide (PbO, PbO₂), copper oxide (CuO, Cu₂O), copper hydroxide, potassium iron oxide (K₂FeO₄), barium iron oxide (BaFeO₄), copper hexacyanoferrate, lithium iron phosphate, lithium nickel manganese cobalt oxide, lithium manganese oxide (LiMn₂O₄, Li₂MnO₃), calix[4]quinone, 1,4-napththoquinone, 9,10-anthraquinone, copper sulfide, nickel sulfide, manganese sulfide, tungsten oxide, tin oxide, tin sulfide, tungsten disulfide, vanadium oxide, or a combination thereof.

A third aspect, which is the battery of the first aspect, wherein the anode material comprises manganese dioxide (MnO₂), manganese oxides (Mn₂O₃, Mn₃O₄, MnO), manganese hydroxides (MnOOH, Mn(OH)₂), silver oxides (AgO, Ag₂O), nickel oxide (NiO, Ni₂O₃), nickel hydroxides (NiOOH, Ni(OH)₂), cobalt oxide (Co₃O₄, CoO), cobalt hydroxides, lead oxide (PbO, PbO₂), copper oxide (CuO, Cu₂O), copper hydroxide, potassium iron oxide (K₂FeO₄), barium iron oxide (BaFeO₄), copper hexacyanoferrate, lithium iron phosphate, lithium nickel manganese cobalt oxide, lithium manganese oxide (LiMn₂O₄, Li₂MnO₃), calix[4]quinone, 1,4-napththoquinone, 9,10-anthraquinone, copper sulfide, nickel sulfide, manganese sulfide, tungsten oxide, tin oxide, tin sulfide, tungsten disulfide, vanadium oxide, or a combination thereof.

A fourth aspect, which is the battery of the first aspect, wherein the cathode and anode contains conductive carbon mixed with the cathode and anode active material where the conductive carbon comprises graphite, carbon fiber, carbon black, acetylene black, single walled carbon nanotubes, multi-walled carbon nanotubes, nickel or copper coated carbon nanotubes, dispersions of single walled carbon nanotubes, dispersions of multi-walled carbon nanotubes, graphene, graphyne, graphene oxide, or a combination thereof.

A fifth aspect, which is the battery of the first aspect, wherein the cathode and anode contain additives or dopants which comprise bismuth oxide, copper oxide, indium hydroxide, indium oxide, aluminum oxide, nickel hydroxide, nickel oxide, silver oxide, cobalt oxide, cobalt hydroxide, lead oxide, lead dioxide, quinones, or a combination thereof.

A sixth aspect, which is the battery of the first aspect, wherein the cathode and anode contains binders comprising methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), polyvinyl alcohol, TEFLON®, or combinations thereof.

A seventh aspect, which is the battery of any of the first, second, third, fourth, fifth and sixth aspects, wherein the cathode and anode are pressed onto a current collector comprising carbon, lead, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, bismuth, titanium, cold rolled steel, half nickel and half copper, carbon foam, carbon felt, polypropylene mesh, or any combination thereof.

An eighth aspect, which is the battery of the seventh aspect, wherein the current collector can be a foil, mesh, perforated foil, foam, honey-combed mesh, sponge-shaped, or any combination thereof.

A ninth aspect, which is the battery of any of the first, second, third, fourth, fifth and sixth aspects, wherein the cathode and anode comprise 1 to 99 wt. % electroactive material, conductive carbon 1 to 99 wt. %, additives 0 to 30 wt. %, and binder 0 to 10 wt. %.

A tenth aspect, which is the battery of any of the first aspect, wherein the catholyte of high proton activity comprises hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, or combinations thereof.

An eleventh aspect, which is the battery of any of the first and tenth aspects, wherein the electrolyte additives to the catholyte comprises of manganese sulfate, nickel sulfate, potassium permanganate, manganese chloride, manganese acetate, manganese triflate, bismuth chloride, bismuth nitrate, manganese nitrate, nickel sulfate, nickel nitrate, zinc sulfate, zinc chloride, zinc acetate, zinc triflate, indium chloride, copper sulfate, copper chloride, lead sulfate, sodium persulfate, potassium persulfate, ammonium persulfate, ammonium chloride, vanillin, potassium chloride, sodium chloride, lithium nitrate, lithium chloride, lithium carbonate, lithium acetate, lithium triflate, aluminum trifluoromethanesulfonate, aluminum chloride, aluminum nitrate, potassium sulfate, sodium sulfate, ammonium sulfate, sodium carbonate, potassium carbonate, potassium bicarbonate, sodium bicarbonate, or combinations thereof.

A twelfth aspect, which is the battery of any of the first aspect, wherein the anolyte with high hydroxyl activity comprises ammonia, methylamine, glycine, lithium hydroxide, sodium hydroxide, potassium hydroxide, caesium hydroxide, rubidium hydroxide, calcium hydroxide, strontium hydroxide, barium hydroxide, or combinations thereof.

A thirteenth aspect, which is the battery of any of the first and twelfth aspects, wherein the electrolyte additives to the anolyte comprise vanillin, indium hydroxide, zinc acetate, zinc oxide, cetyltrimethylammonium bromide, sodium dodecyl sulfate, sodium dodecylbenzene sulfonate, polyethylene glycol, ethanol, methanol, zinc gluconate, manganese gluconate, manganese acetate, glucose, or combinations thereof.

A fourteenth aspect, which is the battery of any of the first, tenth, eleventh, twelfth and thirteenth aspects, wherein the catholyte and anolyte can be gelled or polymerized.

A fifteenth aspect, which is the battery of first aspect, wherein the separator comprises ion-selective gel comprising of ionomers, bipolar membrane, cation-exchange membrane, anion-exchange membrane, cellophane grafted with ion-selective properties, polyvinyl alcohol grafted with ion-selective properties, ceramic separators like NaSiCON, LiSiCON, or combinations thereof.

A sixteenth aspect, which is the battery of any of the first and fifteenth aspects, wherein the separator can be a gelled layer consisting of ion-selective ionomers and buffering agents like potassium carbonate, potassium bicarbonate, sodium carbonate, sodium bicarbonate, etc.; and wherein the ionomers can be perfluorosulfonic acid (PFSA)/polytetrafluoroethylene (PTFE) copolymer in the acid form or anion exchange ionomers with polyaromatic polymer.

A seventeenth aspect, which is a high voltage metal-free battery comprising a cathode comprising a cathode electroactive material, wherein the cathode electroactive material comprises at least one of an organic compound, an oxide, a hydroxide, an oxyhydroxide, a sulfide, and combinations thereof; an anode comprising an anode electroactive material, wherein the anode electroactive material comprises at least one of an organic compound, an oxide, a hydroxide, an oxyhydroxide, a sulfide, and combinations thereof; a catholyte in contact with the cathode, wherein the catholyte is not in contact with the anode, and wherein the catholyte has a pH of less than 4; and an anolyte in contact with the anode, wherein the anolyte is not in contact with the cathode, and wherein the anolyte has a pH of greater than 10.

An eighteenth aspect, which is the battery of the seventeenth aspect, further comprising a separator disposed between the anolyte and the catholyte, wherein the separator has ion-selective properties.

A nineteenth aspect, which is the battery of any of the seventeenth and eighteenth aspects, wherein the anolyte comprises a first gelled electrolyte solution, and wherein the catholyte comprises a second gelled electrolyte solution.

A twentieth aspect, which is the battery of any of the seventeenth through nineteenth aspects, wherein the cathode electroactive material comprises at least one of a manganese oxide, manganese dioxide (MnO₂), Mn₂O₃, Mn₃O₄, MnO; a manganese hydroxide, MnOOH, Mn(OH)₂; a silver oxide, AgO, Ag₂O; a nickel oxide, NiO, Ni₂O₃; a nickel hydroxide, NiOOH, Ni(OH)₂; a cobalt oxide, Co₃O₄, CoO; a cobalt hydroxide; a lead oxide, PbO, PbO₂; a copper oxide, CuO, Cu₂O; a copper hydroxide; potassium iron oxide (K₂FeO₄); barium iron oxide (BaFeO₄); copper hexacyanoferrate; lithium iron phosphate; lithium nickel manganese cobalt oxide; a lithium manganese oxide, LiMn₂O₄, Li₂MnO₃; calix[4]quinone; 1,4-napththoquinone; 9,10-anthraquinone; copper sulfide; nickel sulfide; manganese sulfide; tungsten oxide; tin oxide; tin sulfide; tungsten disulfide; vanadium oxide; and any mixture thereof.

A twenty-first aspect, which is the battery of any of the seventeenth through twentieth aspects, wherein the anode electroactive material comprises at least one of a manganese oxide, manganese dioxide (MnO₂), Mn₂O₃, Mn₃O₄, MnO; a manganese hydroxide, MnOOH, Mn(OH)₂; a silver oxide, AgO, Ag₂O; a nickel oxide, NiO, Ni₂O₃; a nickel hydroxide, NiOOH, Ni(OH)₂; a cobalt oxide, Co₃O₄, CoO; a cobalt hydroxide; a lead oxide, PbO, PbO₂; a copper oxide, CuO, Cu₂O; a copper hydroxide; potassium iron oxide (K₂FeO₄); barium iron oxide (BaFeO₄); copper hexacyanoferrate; lithium iron phosphate; lithium nickel manganese cobalt oxide; a lithium manganese oxide, LiMn₂O₄, Li₂MnO₃; calix[4]quinone; 1,4-napththoquinone; 9,10-anthraquinone; copper sulfide; nickel sulfide; manganese sulfide; tungsten oxide; tin oxide; tin sulfide; tungsten disulfide; vanadium oxide; and any mixture thereof.

A twenty-second aspect, which is the battery of any of the seventeenth through twenty-first aspects, wherein the cathode, the anode, or both comprise a conductive carbon; wherein the conductive carbon is mixed with the cathode electroactive material, anode electroactive material, or both, respectively; and wherein the conductive carbon comprises graphite, carbon fiber, carbon black, acetylene black, single walled carbon nanotubes, multi-walled carbon nanotubes, nickel coated carbon nanotubes, copper coated carbon nanotubes, dispersions of single walled carbon nanotubes, dispersions of multi-walled carbon nanotubes, graphene, graphyne, graphene oxide, and combinations thereof.

A twenty-third aspect, which is the battery of any of the seventeenth through twenty-second aspects, wherein the cathode, the anode, or both comprise an additive and/or dopant; and wherein the additive and/or dopant comprises bismuth oxide, copper oxide, indium hydroxide, indium oxide, aluminum oxide, nickel hydroxide, nickel oxide, silver oxide, cobalt oxide, cobalt hydroxide, lead oxide, lead dioxide, quinones, or a combination thereof.

A twenty-fourth aspect, which is the battery of any of the seventeenth through twenty-third aspects, wherein wherein the cathode, the anode, or both comprise a binder; and wherein the binder comprises methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), polyvinyl alcohol, TEFLON, or a combination thereof.

A twenty-fifth aspect, which is the battery of any of the seventeenth through twenty-fourth aspects, wherein wherein the cathode, the anode, or both comprise a pressed cathode material on a current collector; wherein the current collector comprises carbon, lead, nickel, steel, stainless steel, nickel-coated steel, nickel plated copper, tin-coated steel, copper plated nickel, silver coated copper, copper, magnesium, aluminum, tin, iron, platinum, silver, gold, bismuth, titanium, cold rolled steel, half nickel and half copper, polypropylene, or any combination thereof.

A twenty-sixth aspect, which is the battery of the twenty-fifth aspect, wherein the current collector is a foil, mesh, perforated foil, foam, felt, fibrous, porous block architecture, honey-combed mesh, sponge-shaped, or any combinations thereof.

A twenty-seventh aspect, which is the battery of any of the seventeenth through twenty-sixth aspects, wherein the cathode comprises 1-99 wt. % of a cathode electroactive material, 1-99 wt. % of a conductive carbon, 0-30 wt. % of an additive and/or dopant, and 0-10 wt. % of a binder, based on a total weight of the cathode.

A twenty-eighth aspect, which is the battery of any of the seventeenth through twenty-seventh aspects, wherein the anode comprises 1-99 wt. % of an anode electroactive material, 1-99 wt. % of a conductive carbon, 0-30 wt. % of an additive and/or dopant, and 0-10 wt. % of a binder, based on a total weight of the anode.

A twenty-ninth aspect, which is the battery of any of the seventeenth through the twenty-eighth aspects, wherein the catholyte comprises an acidic electrolyte; and wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof.

A thirtieth aspect, which is the battery of any of the seventeenth through twenty-ninth aspects, wherein the acidic electrolyte is present in the catholyte in a concentration of between about 0.1 M and about 16 M.

A thirty-first aspect, which is the battery of any of the seventeenth through thirtieth aspects, wherein the catholyte comprises a catholyte additive; and wherein the catholyte additive comprises at least one of manganese sulfate, nickel sulfate, potassium permanganate, manganese chloride, manganese acetate, manganese triflate, bismuth chloride, bismuth nitrate, manganese nitrate, nickel sulfate, nickel nitrate, zinc sulfate, zinc chloride, zinc acetate, zinc triflate, indium chloride, copper sulfate, copper chloride, lead sulfate, sodium persulfate, potassium persulfate, ammonium persulfate, ammonium chloride, vanillin, potassium chloride, sodium chloride, lithium nitrate, lithium chloride, lithium carbonate, lithium acetate, lithium triflate, aluminum trifluoromethanesulfonate, aluminum chloride, aluminum nitrate, potassium sulfate, sodium sulfate, ammonium sulfate, sodium carbonate, potassium carbonate, potassium bicarbonate, sodium bicarbonate, and any mixture thereof.

A thirty-second aspect, which is the battery of any of the seventeenth through thirty-first aspects, wherein the anolyte comprises an alkaline electrolyte; and wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof.

A thirty-third aspect, which is the battery of the thirty-second aspect, wherein the alkaline electrolyte is present in the anolyte in an amount of 10-60 wt. %, based on the total weight of the anolyte.

A thirty-fourth aspect, which is the battery of any of the seventeenth through thirty-third aspects, wherein the anolyte comprises an anolyte additive; and wherein the anolyte additive comprises at least one of vanillin, indium hydroxide, zinc acetate, zinc oxide, cetyltrimethylammonium bromide, sodium dodecyl sulfate, sodium dodecylbenzene sulfonate, polyethylene glycol, ethanol, methanol, zinc gluconate, manganese gluconate, manganese acetate, glucose, and any mixture thereof.

A thirty-fifth aspect, which is the battery of any of the seventeenth through thirty-fourth aspects, wherein the catholyte, the anolyte, or both are gelled or polymerized.

A thirty-sixth aspect, which is the battery of any of second aspect, wherein the separator comprises an ion-selective gel; and wherein the ion-selective gel comprises an ionomer, a bipolar membrane, a cation-exchange membrane, an anion-exchange membrane, a cellophane grafted with ion-selective properties, a polyvinyl alcohol grafted with ion-selective properties, a ceramic separator, NaSiCON, LiSiCON, or any combination thereof.

A thirty-seventh aspect, which is the battery of the second aspect, wherein the separator is a gelled layer consisting of ion-selective ionomers and buffering agents; wherein the buffering agents comprise potassium carbonate, potassium bicarbonate, sodium carbonate, sodium bicarbonate, or any combination thereof; and wherein the ionomers comprise a perfluorosulfonic acid (PFSA)/polytetrafluoroethylene (PTFE) copolymer in the acid form, an anion exchange ionomer with a polyaromatic polymer, or combinations thereof.

A thirty-eighth aspect, which is the battery of any of the seventeenth through thirty-seventh aspects, wherein the battery is characterized by an average discharge potential of from greater than about 1.6 V to about 5 V.

A thirty-ninth aspect, which is the battery of any of the seventeenth through thirty-eighth aspects, wherein the battery is characterized by an average discharge potential of from equal to or greater than about 2 V to about 5 V.

A fortieth aspect, which is a high voltage metal-free battery comprising a cathode comprising a cathode electroactive material, wherein the cathode electroactive material comprises at least one of an organic compound, an oxide, a hydroxide, an oxyhydroxide, a sulfide, and combinations thereof; an anode comprising an anode electroactive material, wherein the anode electroactive material comprises at least one of an organic compound, an oxide, a hydroxide, an oxyhydroxide, a sulfide, and combinations thereof; a catholyte in contact with the cathode, wherein the catholyte is not in contact with the anode, and wherein the catholyte has a pH of less than 2; an anolyte in contact with the anode, wherein the anolyte is not in contact with the cathode, and wherein the anolyte has a pH of greater than 12; and a separator disposed between the anolyte and the catholyte, wherein the separator has ion-selective properties.

A forty-first aspect, which is the battery of the fortieth aspect, wherein the catholyte comprises an acidic electrolyte; wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof; and wherein the acidic electrolyte is present in the catholyte in a concentration of between about 1 M and about 16 M.

A forty-second aspect, which is the battery of any of the fortieth and forty-first aspects, wherein the anolyte comprises an alkaline electrolyte; wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof; and wherein the alkaline electrolyte is present in the anolyte in an amount of 20-60 wt. %, based on the total weight of the anolyte.

A forty-third aspect, which is the battery of any of the fortieth through forty-second aspects, wherein the battery is characterized by an average discharge potential of from about 2 V to about 5 V.

A forty-fourth aspect, which is a method of forming a high voltage metal-free battery, the method comprising disposing a catholyte in contact with a cathode, wherein the cathode comprises a cathode electroactive material; wherein the cathode electroactive material comprises at least one of an organic compound, an oxide, a hydroxide, an oxyhydroxide, a sulfide, and combinations thereof; and wherein the catholyte has a pH of less than 4; disposing an anolyte in contact with an anode; wherein the anode comprises an anode electroactive material, wherein the anode electroactive material comprises at least one of an organic compound, an oxide, a hydroxide, an oxyhydroxide, a sulfide, and combinations thereof; and wherein the anolyte has a pH of greater than 10; and disposing at least one of a separator or a buffer layer between the anolyte and the catholyte, wherein the catholyte is not in contact with the anode, and wherein the anolyte is not in contact with the cathode.

A forty-fifth aspect, which is the method of the forty-fourth aspect, wherein further comprising disposing the catholyte, the anolyte, the anode, the cathode, and the separator or buffer layer in a housing to form the high voltage metal-free battery.

A forty-sixth aspect, which is the method of any of the forty-fourth and forty-fifth aspects, wherein the separator or buffer layer has ion-selective properties.

A forty-seventh aspect, which is the method of any of the forty-fourth through forty-sixth aspects, wherein the catholyte comprises an acidic electrolyte; wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof; and wherein the acidic electrolyte is present in the catholyte in a concentration of between about 1 M and about 16 M.

A forty-eighth aspect, which is the method of any of the forty-fourth through forty-seventh aspects, wherein the anolyte comprises an alkaline electrolyte; wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof; and wherein the alkaline electrolyte is present in the anolyte in an amount of 20-60 wt. %, based on the total weight of the anolyte.

A forty-ninth aspect, which is a method for producing energy comprising discharging a high voltage metal-free battery to a discharge voltage to produce energy, wherein the high voltage metal-free battery comprises a cathode comprising a cathode electroactive material; wherein the cathode electroactive material comprises at least one of an organic compound, an oxide, a hydroxide, an oxyhydroxide, a sulfide, and combinations thereof; an anode comprising an anode electroactive material; wherein the anode electroactive material comprises at least one of an organic compound, an oxide, a hydroxide, an oxyhydroxide, a sulfide, and combinations thereof; and wherein at least a portion of the anode electroactive material is oxidized during the discharging to form an oxidized anode material; a catholyte in contact with the cathode, wherein the catholyte is not in contact with the anode, and wherein the catholyte has a pH of less than 4; and an anolyte in contact with the anode, wherein the anolyte is not in contact with the cathode, and wherein the anolyte has a pH of greater than 10; and charging the high voltage metal-free battery to a charge voltage, wherein at least a portion of the oxidized anode material is reduced to the anode electroactive material during the charging.

A fiftieth aspect, which is the method of the forty-ninth aspect, wherein the discharge voltage is equal to or greater than about 2 V.

A fifty-first aspect, which is the method of any of the forty-ninth and fiftieth aspects, wherein the catholyte comprises an acidic electrolyte; wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof; and wherein the acidic electrolyte is present in the catholyte in a concentration of between about 1 M and about 16 M.

A fifty-second aspect, which is the method of any of the forty-ninth through fifty-first aspects, wherein the anolyte comprises an alkaline electrolyte; wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof; and wherein the alkaline electrolyte is present in the anolyte in an amount of 20-60 wt. %, based on the total weight of the anolyte.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A high voltage metal-free battery comprising:
a cathode comprising a cathode electroactive material, wherein the cathode electroactive material comprises at least one of an organic compound, an oxide, a hydroxide, an oxyhydroxide, a sulfide, and combinations thereof;
an anode comprising an anode electroactive material, wherein the anode electroactive material comprises at least one of an organic compound, an oxide, a hydroxide, an oxyhydroxide, a sulfide, and combinations thereof;
a catholyte in contact with the cathode, wherein the catholyte is not in contact with the anode, and wherein the catholyte has a pH of less than 4; and
an anolyte in contact with the anode, wherein the anolyte is not in contact with the cathode, and wherein the anolyte has a pH of greater than 10.

2. The battery of claim 1, wherein at least one of the cathode electroactive material or the anode electroactive material does not have a metal in an oxidation state of zero.

3. The battery of claim 1, further comprising a separator disposed between the anolyte and the catholyte, wherein the separator has ion-selective properties.

4. The battery of claim 3, wherein the separator comprises an ion-selective gel; and wherein the ion-selective gel comprises an ionomer, a bipolar membrane, a cation-exchange membrane, an anion-exchange membrane, a cellophane grafted with ion-selective properties, a polyvinyl alcohol grafted with ion-selective properties, a ceramic separator, NaSiCON, LiSiCON, or any combination thereof.

5. The battery of claim 3, wherein the separator is a gelled layer consisting of ion-selective ionomers and buffering agents; wherein the buffering agents comprise potassium carbonate, potassium bicarbonate, sodium carbonate, sodium bicarbonate, or any combination thereof; and wherein the ionomers comprise a perfluorosulfonic acid (PFSA)/polytetrafluoroethylene (PTFE) copolymer in the acid form, an anion exchange ionomer with a polyaromatic polymer, or combinations thereof.

6. The battery of claim 1, wherein the anolyte comprises a first gelled electrolyte solution, and wherein the catholyte comprises a second gelled electrolyte solution.

7. The battery of claim 1, wherein the cathode electroactive material comprises at least one of a manganese oxide, manganese dioxide (MnO₂), Mn₂O₃, Mn₃O₄, MnO; a manganese hydroxide, MnOOH, Mn(OH)₂; a silver oxide, AgO, Ag₂O; a nickel oxide, NiO, Ni₂O₃; a nickel hydroxide, NiOOH, Ni(OH)₂; a cobalt oxide, Co₃O₄, CoO; a cobalt hydroxide; a lead oxide, PbO, PbO₂; a copper oxide, CuO, Cu₂O; a copper hydroxide; potassium iron oxide (K₂FeO₄); barium iron oxide (BaFeO₄); copper hexacyanoferrate; lithium iron phosphate; lithium nickel manganese cobalt oxide; a lithium manganese oxide, LiMn₂O₄, Li₂MnO₃; calix[4]quinone; 1,4-napththoquinone; 9,10-anthraquinone; copper sulfide; nickel sulfide; manganese sulfide; tungsten oxide; tin oxide; tin sulfide; tungsten disulfide; vanadium oxide; and any mixture thereof.

8. The battery of claim 1, wherein the anode electroactive material comprises at least one of a manganese oxide, manganese dioxide (MnO₂), Mn₂O₃, Mn₃O₄, MnO; a manganese hydroxide, MnOOH, Mn(OH)₂; a silver oxide, AgO, Ag₂O; a nickel oxide, NiO, Ni₂O₃; a nickel hydroxide, NiOOH, Ni(OH)₂; a cobalt oxide, Co₃O₄, CoO; a cobalt hydroxide; a lead oxide, PbO, PbO₂; a copper oxide, CuO, Cu₂O; a copper hydroxide; potassium iron oxide (K₂FeO₄); barium iron oxide (BaFeO₄); copper hexacyanoferrate; lithium iron phosphate; lithium nickel manganese cobalt oxide; a lithium manganese oxide, LiMn₂O₄, Li₂MnO₃; calix[4]quinone; 1,4-napththoquinone; 9,10-anthraquinone; copper sulfide; nickel sulfide; manganese sulfide; tungsten oxide; tin oxide; tin sulfide; tungsten disulfide; vanadium oxide; and any mixture thereof.

9. The battery of claim 1, wherein the cathode, the anode, or both comprise a conductive carbon; wherein the conductive carbon is mixed with the cathode electroactive material, anode electroactive material, or both, respectively; and wherein the conductive carbon comprises graphite, carbon fiber, carbon black, acetylene black, single walled carbon nanotubes, multi-walled carbon nanotubes, nickel coated carbon nanotubes, copper coated carbon nanotubes, dispersions of single walled carbon nanotubes, dispersions of multi-walled carbon nanotubes, graphene, graphyne, graphene oxide, and combinations thereof.

10. The battery of claim 1, wherein the cathode, the anode, or both comprise an additive and/or dopant; and wherein the additive and/or dopant comprises bismuth oxide, copper oxide, indium hydroxide, indium oxide, aluminum oxide, nickel hydroxide, nickel oxide, silver oxide, cobalt oxide, cobalt hydroxide, lead oxide, lead dioxide, quinones, or a combination thereof.

11. The battery of claim 1, wherein the cathode, the anode, or both comprise a binder; and wherein the binder comprises methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), polyvinyl alcohol, TEFLON, or a combination thereof.

12.-13. (canceled)

14. The battery of claim 1, wherein the cathode comprises 1-99 wt. % of a cathode electroactive material, 1-99 wt. % of a conductive carbon, 0-30 wt. % of an additive and/or dopant, and 0-10 wt. % of a binder, based on a total weight of the cathode, and wherein the anode comprises 1-99 wt. % of an anode electroactive material, 1-99 wt. % of a conductive carbon, 0-30 wt. % of an additive and/or dopant, and 0-10 wt. % of a binder, based on a total weight of the anode.

15. (canceled)

16. The battery of claim 1, wherein the catholyte comprises an acidic electrolyte; and wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof, and wherein the acidic electrolyte is present in the catholyte in a concentration of between about 0.1 M and about 16 M.

17. (canceled)

18. The battery of claim 1, wherein the catholyte comprises a catholyte additive; and wherein the catholyte additive comprises at least one of manganese sulfate, nickel sulfate, potassium permanganate, manganese chloride, manganese acetate, manganese triflate, bismuth chloride, bismuth nitrate, manganese nitrate, nickel sulfate, nickel nitrate, zinc sulfate, zinc chloride, zinc acetate, zinc triflate, indium chloride, copper sulfate, copper chloride, lead sulfate, sodium persulfate, potassium persulfate, ammonium persulfate, ammonium chloride, vanillin, potassium chloride, sodium chloride, lithium nitrate, lithium chloride, lithium carbonate, lithium acetate, lithium triflate, aluminum trifluoromethanesulfonate, aluminum chloride, aluminum nitrate, potassium sulfate, sodium sulfate, ammonium sulfate, sodium carbonate, potassium carbonate, potassium bicarbonate, sodium bicarbonate, and any mixture thereof.

19. The battery of claim 1, wherein the anolyte comprises an alkaline electrolyte; and wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof, and wherein the alkaline electrolyte is present in the anolyte in an amount of 10-60 wt. %, based on the total weight of the anolyte.

20. (canceled)

21. The battery of claim 1, wherein the anolyte comprises an anolyte additive; and wherein the anolyte additive comprises at least one of vanillin, indium hydroxide, zinc acetate, zinc oxide, cetyltrimethylammonium bromide, sodium dodecyl sulfate, sodium dodecylbenzene sulfonate, polyethylene glycol, ethanol, methanol, zinc gluconate, manganese gluconate, manganese acetate, glucose, and any mixture thereof.

22. (canceled)

23. The battery of claim 1, wherein the battery is characterized by an average discharge potential of from greater than about 1.6 V to about 5 V.

24.

25. The battery of claim 1,
wherein the catholyte has a pH of less than 2;
wherein the anolyte has a pH of greater than 12; and
wherein the battery further comprises a separator disposed between the anolyte and the catholyte, wherein the separator has ion-selective properties.

26.-28. (canceled)

29. A method of forming a high voltage metal-free battery, the method comprising:
disposing a catholyte in contact with a cathode, wherein the cathode comprises a cathode electroactive material; wherein the cathode electroactive material comprises at least one of an organic compound, an oxide, a hydroxide, an oxyhydroxide, a sulfide, and combinations thereof; and wherein the catholyte has a pH of less than 4;
disposing an anolyte in contact with an anode; wherein the anode comprises an anode electroactive material, wherein the anode electroactive material comprises at least one of an organic compound, an oxide, a hydroxide, an oxyhydroxide, a sulfide, and combinations thereof; and wherein the anolyte has a pH of greater than 10; and
disposing at least one of a separator or a buffer layer between the anolyte and the catholyte, wherein the catholyte is not in contact with the anode, and wherein the anolyte is not in contact with the cathode.

30. The method of claim 29, further comprising disposing the catholyte, the anolyte, the anode, the cathode, and the separator or buffer layer in a housing to form the high voltage metal-free battery.

31. The method of claim 29, wherein the separator or buffer layer has ion-selective properties.

32. The method of claim 29, wherein the catholyte comprises an acidic electrolyte; wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof; and wherein the acidic electrolyte is present in the catholyte in a concentration of between about 1 M and about 16 M.

33. The method of claim 29, wherein the anolyte comprises an alkaline electrolyte; wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof; and wherein the alkaline electrolyte is present in the anolyte in an amount of 20-60 wt. %, based on the total weight of the anolyte.

34. A method for producing energy comprising:
discharging a high voltage metal-free battery to a discharge voltage to produce energy, wherein the high voltage metal-free battery comprises:
a cathode comprising a cathode electroactive material; wherein the cathode electroactive material comprises at least one of an organic compound, an oxide, a hydroxide, an oxyhydroxide, a sulfide, and combinations thereof;
an anode comprising an anode electroactive material; wherein the anode electroactive material comprises at least one of an organic compound, an oxide, a hydroxide, an oxyhydroxide, a sulfide, and combinations thereof; and wherein at least a portion of the anode electroactive material is oxidized during the discharging to form an oxidized anode material;
a catholyte in contact with the cathode, wherein the catholyte is not in contact with the anode, and wherein the catholyte has a pH of less than 4; and
an anolyte in contact with the anode, wherein the anolyte is not in contact with the cathode, and wherein the anolyte has a pH of greater than 10; and
charging the high voltage metal-free battery to a charge voltage, wherein at least a portion of the oxidized anode material is reduced to the anode electroactive material during the charging.

35. The method of claim 34, wherein the discharge voltage is equal to or greater than about 2 V.

36. The method of claim 34, wherein the catholyte comprises an acidic electrolyte; wherein the acidic electrolyte comprises at least one of hydrogen phosphate, bicarbonates, ammonium cation, hydrogen sulfide, acetic acid, hydrogen fluoride, phosphoric acid, sulfuric acid, nitric acid, hydrochloric acid, hydrogen bromide, hydroiodic acid, triflic acid, and any mixture thereof; and wherein the acidic electrolyte is present in the catholyte in a concentration of between about 1 M and about 16 M.

37. The method of claim 34, wherein the anolyte comprises an alkaline electrolyte; wherein the alkaline electrolyte comprises at least one of ammonia, methylamine, glycine, lithium hydroxide, sodium hydroxide, potassium hydroxide, caesium hydroxide, rubidium hydroxide, calcium hydroxide, strontium hydroxide, barium hydroxide, and any mixture thereof; and wherein the alkaline electrolyte is present in the anolyte in an amount of 20-60 wt. %, based on the total weight of the anolyte.
